(19) United States
(12) Patent Application Publication
(10) Pub. No.: US 2025/0175449 A1
(43) Pub. Date: May 29, 2025

(54) COMMUNICATE DNS ZONE METADATA TO DYNAMIC NAMESERVER PROXIES

(71) Applicant: Oracle International Corporation, Redwood Shores, CA (US)

(72) Inventors: James Joseph Stadtmiller, Canterbury, NH (US); Peter Michael Thornewell, Seattle, WA (US); Paul Coiner, Saint Cloud, FL (US)

(73) Assignee: Oracle International Corporation, Redwood Shores, CA (US)

(21) Appl. No.: 18/886,544

(22) Filed: Sep. 16, 2024

Related U.S. Application Data
(60) Provisional application No. 63/604,111, filed on Nov. 29, 2023.

(51) Int. Cl. H04L 61/4552; H04L 9/32; H04L 61/4511

(52) U.S. Cl. CPC H04L 61/4552; H04L 9/3247; H04L 61/4511

(57) ABSTRACT

Techniques and devices are described for communicating domain name system zone metadata to dynamic nameserver proxies. A method can include signing service receiving a first request for a resource record (RR). The signing service can transmit to a backend unit, a domain name system (DNS) query for information associated with a subdomain. The signing service can receive, from the backend unit of the computing system, a first DNS response comprising the information associated with the subdomain. The signing service can determine whether the information comprises a flagged nameserver record. The signing service can generate a second DNS response, content of the DNS response based at least in part on whether the information associated with the subdomain comprises the flagged nameserver record. The signing service can transmit the second DNS response to the DNS resolver.

### CROSS-REFERENCES TO RELATED APPLICATIONS

This application claims the benefit of U.S. Provisional Application No. 63/604,111, filed on Nov. 29, 2023, which is incorporated by reference.

### BACKGROUND

A cloud service provider (CSP) can provide multiple cloud services to subscribing customers. These services are provided under different models, including a Software-as-a-Service (SaaS) model, a Platform-as-a-Service (PaaS) model, an Infrastructure-as-a-Service (IaaS) model, and others. The CSP can include a domain name system (DNS) for determining an IP address of a CSP-controlled resource based on a domain name.

### BRIEF SUMMARY

A domain name system (DNS) can be a hierarchical key value store that can be used to translate text-based domain names into machine-readable internet protocol (IP) addresses. For example, a web browser can process a domain name (e.g., example.com). The web browser can contact a DNS server that can translate the domain name into an IP address (e.g., 192.158.1.40). The DNS server can return the IP address to the web browser, and the web browser can use the IP address to connect to the domain. A DNS hierarchy can include a domain (e.g., parent domain) and a subdomain (e.g., @subdomain). A domain can include a higher level domain than a subdomain (e.g., subdomain). The domain can delegate authority for the subdomain to a particular DNS server. A DNS resolver can include software for receiving a domain name from an application and determining an internet protocol (IP) for the domain name. Therefore, the DNS resolver may be requested to contact other servers to determine the IP address of the desired domain. For example, the DNS resolver may be requested to contact a root server to access the IP address of a top level domain (TLD) server. The DNS resolver may be requested to contact the TLD server to access an IP address of an authoritative nameserver that stores the IP address for the domain. The DNS resolver may then be requested to contact the authoritative nameserver to access the IP address of the domain. The DNS resolver can then store the IP address in cache and provide the IP address to the web browser.

The embodiments described herein are directed toward a techniques and devices for communicating DNS metadata to dynamic DNS computing systems. Example techniques and devices can include a signing service of a computing system receiving from a domain name system (DNS) resolver, a first request for a resource record (RR).

The techniques and devices can further include the signing service of a computing system transmitting to a backend unit of the computing system, a domain name system (DNS) query for information associated with the subdomain.

The techniques and devices can further include the signing service of the computing system receiving from the backend unit of the computing system, a first domain name system (DNS) response comprising the information associated with the subdomain.

The techniques and devices can further include the signing service of the computing system determining whether the information associated with the subdomain comprises a flagged nameserver (NS) record.

The techniques and devices can further include the signing service of the computing system generating a second domain name system (DNS) response, content of the domain name system (DNS) response based at least in part on whether the information associated with the subdomain comprises the flagged nameserver record.

The techniques and devices can further include the signing service of the computing system transmitting the second domain name system (DNS) response to the domain name system (DNS) resolver.

### BRIEF DESCRIPTION OF THE DRAWINGS

FIG. 1 is an illustration of an example domain name system (DNS), according to one or more embodiments.

FIG. 2 is an illustration of an example DNS query message according to one or more embodiments.

FIG. 3 is an illustration of an example DNS response message according to one or more embodiments.

FIG. 4 is an illustration of an example, DNS zone file, according to one or more embodiments.

FIG. 5 is an example signaling diagram for generating a DNS response, according to one or more embodiments.

FIG. 6 is an example signaling diagram for generating a DNS response, according to one or more embodiments.

FIG. 7 is an example process flow for generating a DNS response, according to one or more embodiments.

FIG. 8 is a block diagram illustrating one pattern for implementing a cloud infrastructure as a service system, according to at least one embodiment.

FIG. 9 is a block diagram illustrating another pattern for implementing a cloud infrastructure as a service system, according to at least one embodiment.

FIG. 10 is a block diagram illustrating another pattern for implementing a cloud infrastructure as a service system, according to at least one embodiment.

FIG. 11 is a block diagram illustrating another pattern for implementing a cloud infrastructure as a service system, according to at least one embodiment.

FIG. 12 is a block diagram illustrating an example computer system, according to at least one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

A domain name system (DNS) can be a distributed hierarchical key value store that can be used to map text-based domain names into machine-readable internet protocol (IP) addresses. A DNS resolver can receive a domain name from an application and determine an internet protocol (IP) for the domain name. In some instances, the DNS resolver may be requested to contact other servers to determine the IP address of the desired domain. For example, the DNS resolver may be requested to contact a root server to access the IP address of a top level domain (TLD) server. The DNS resolver may be requested to contact the TLD server to access an IP address of an authoritative nameserver that stores the IP address for the domain. The DNS resolver may then be requested to contact the authoritative NS to access the IP address of the domain. The DNS resolver can then store the IP address in cache and provide the IP address to the web browser.

Given the number of connections that the DNS resolver makes with other servers prior to accessing the IP address, a malicious actor has multiple opportunities to disrupt the flow of information by, for example, directing the DNS resolver to a malicious server. To remedy this issue, a DNS can use DNS security extension (DNSSEC) that can include a set of extensions for adding security layers to the DNS system. The DNSSEC can introduce cryptographic signatures, such that records can be signed by an authoritative nameserver of a DNS zone prior to being returned to a receiving server. A zone can be a portion of a DNS namespace that is managed by a particular DNS server. The receiving server can authenticate the cryptographic signature using, for example, a public key. The DNSSEC can further be used to establish a hierarchical chain of trust from the root, to the TLD, and down to the domain. Each level of the chain of trust can include its own set of cryptographic keys and each level can sign a record for the level below. A receiving server can then perform a look up authenticating the cryptographic signatures from the lowest level up to the root level.

There is no requirement that every domain is DNSSEC-enabled. For example, the domain can be DNSSEC-enabled such that when an authoritative nameserver for the domain transmits a DNS message, the authoritative nameserver can use signing materials (e.g., a public key/private key pair) to add a cryptographic signature to the DNS message. However, there may be no requirement that the subdomain is also DNSSEC-enabled. If the subdomain is not DNSSEC-enabled, there may be no requirement for a cryptographic signature. One issue that can arise is that an authoritative nameserver for a domain receives a request for information involving a subdomain. The authoritative nameserver for the domain can search its records for information regarding the subdomain. The authoritative nameserver may not be able to easily determine from the information as to whether the subdomain is DNSSEC-enabled. 7.

Embodiments described herein address the above-referenced issues by providing techniques for signaling a zone-level policy using a flag in a nameserver record. The flagged NS record can be a signal to the authoritative nameserver for the domain as to whether to include a cryptographic signature along with the response. If the authoritative nameserver for the domain detects a flagged NS record, the authoritative nameserver can use the flagged NS record to access signing materials to generate a cryptographic signature. If, however, the authoritative nameserver does not detect the flagged NS record, the authoritative nameserver does not sign the response to the request. A technical advantage of the embodiments described herein includes reducing the volume of data that a system distributes in order to communicate to servers generating DNSSEC signatures. For example, a conventional system may include information about every single DNS zone in the system with a “no signing materials” detail for zones which are not DNSSEC-enabled. Given that a system can include one hundred thousand zones that can change based on customer preference, the cost to establish and maintain this information may be significant. The herein described techniques can reduce the list by introducing the flagged NS records that can convey the same information as the list.

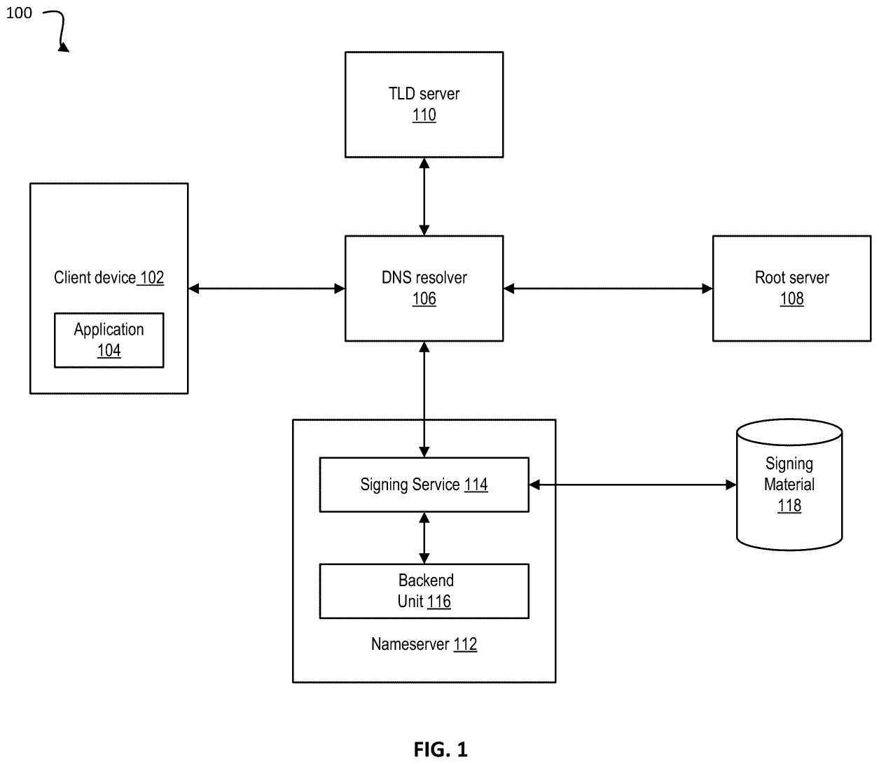

FIG. 1 is an illustration 100 of an example DNS system, according to one or more embodiments. A client device 102, and in particular an application 104 (e.g., web browser) can receive a domain name (www.child.example.com) from a user. The application 104 can connect to the domain using an IP address (e.g., 192.158.1.22) for the domain, if the application 104 has the IP address. If the application 104 does not have the IP address, the application 104 can transmit a query for the IP address to a DNS resolver 106. The query can further indicate that the application is DNSSEC-enabled. The DNS resolver 106 can access a local cache to determine whether the IP address has previously been stored. If the IP address is stored in the local cache, the DNS resolver 106 can return the IP address to the application 104.

If, however, the IP address is not stored in the local cache, the DNS resolver 106 can transmit a query to a root DNS server 108 for TLD information for an authoritative TLD server. The query can further indicate that the DNS resolver 106 is DNSSEC-enabled. The root DNS server 108 can include information about various TLDs (e.g., .com, .edu, and .com). The root DNS server 108 can direct the DNS resolver 106 to an authoritative server for a TLD. In this example, the domain is example.com, and therefore the root DNS server 108 can provide the DNS resolver 106 information directing the DNS resolver 106 to the TLD server 110, which can be an authoritative server for .com.

The DNS resolver 106 can transmit a query to a TLD server 110 information regarding an authoritative server for a domain (e.g., example.com). The query can further indicate that the DNS resolver 106 is DNSSEC-enabled. The TLD server 110 can return the requested information to the DNS resolver 106.

The DNS resolver 106 can transmit a query to a nameserver 112 based on the returned information. The query can include an indication that the DNS resolver 106 is DNSSEC-enabled and capable of validating a DNSSEC signed resource record (RR). An RR can include information about a resource (e.g., a nameserver identity, an IP address). If a server is DNSSEC-enabled, the server can sign a DNS response message that includes the RR prior to transmitting the message to the DNS resolver 106. The nameserver 112 can include a signing service 114 and a backend unit 116. A signing service 114 can be software that is operable to generate a cryptographic signature to be included with a DNS response message. The signing service 114 can transmit a request to the backend unit 116 for a RRs related to a particular domain. For example, the signing service 114 can request all of the nameserver records for example.com. Alternatively, the signing service 114 can request address (A) records for child.example.com. It should be appreciated that the techniques are described herein with respect to a signing service. However, one having ordinary skill the art can recognize that the herein described techniques can be used in various applications. For example, the techniques described herein can be used for load balancing. For example, a proxy can use a flagged nameserver record to determine a load balancing decision, as the flag can guide the load balancing behavior of the proxy.

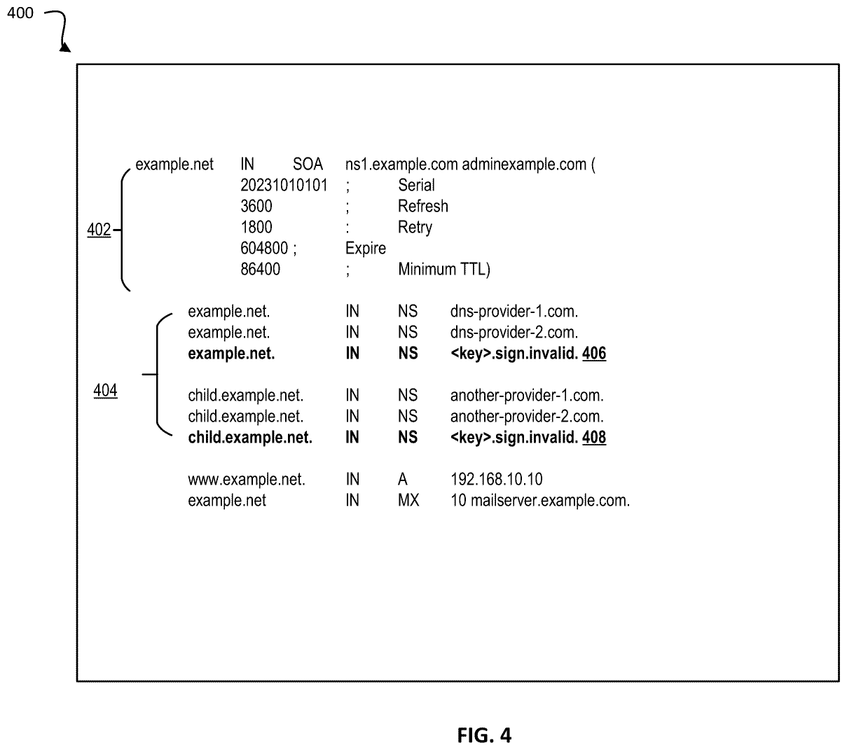

The backend unit 116 can return the requested records to the signing service 114 for the requested domain. The records can include a flagged NS record described with more particularly with respect to FIG. 4. The flagged NS record can include a key and a particular suffix (e.g., .invalid). The suffix can be a signal to the signing service 114 to extract the key. The key can be any value that the signing service 114 can use as an index value to search a signing material database 118. The key can be, for example, a hash value that the signing service 114 can use to map to signing material (e.g., a public key and/or a private key) for a particular domain stored in the signing material database 118. The signing service 114 can be configured to treat the flagged NS record as not a real NS record and favor any other NS records for the domain that are received from the backend unit 116. In some embodiments, the signing service 114 can be configured to filter out the flagged NS record prior to returning a response to the DNS resolver. In this sense, the DNS resolver 106 may be unaware of the use of the flagged NS record in generating the response.

The signing service 114 can generate a DNS response that includes a resource records set (RRSET) for the DNS resolver 106. The RRSET can include a set of all resource records of a given record type and given name. The DNS response can include nameserver information, such as the domain name, time-to-live (TTL) information, and a delegation as to which servers are authoritative for a given zone. The TTL can be a time limit for how long the DNS resolver 106 can cache the record before having to ask for the information again. The information in the DNS response can also include any requested address records (e.g., “A” records). The information can also include MX records for mail servers of the desired domain.

The DNS response can also include a resource record signature (RRSIG) RR that can include a cryptographic signature. The signing service 114 can use the key value to access signing material for the domain from the signing material database 118 and generate the cryptographic signature. For example, the signing service 114 can use the private key associated with the domain to generate a cryptographic signature and store the cryptographic signature in the RRSIG RR.

In one example, the query can be for the domain, and the nameserver 112 can be both DNSSEC-enabled and the authoritative nameserver for a domain (e.g., example.com), but may or may not be the authoritative nameserver for the subdomain (e.g., child.example.com). The signing service 114 can request records from the backend unit 116, and the backend unit 116 can return NS records associated with the domain. The NS records can include a flagged NS record that includes a key value. The key value can map to signing material for the domain. The signing service 114 can generate a cryptographic signature using the signing material and transmit a response to the DNS resolver 106 that includes any requested records and the cryptographic signature.

In another example, the query from the DNS resolver 106 is for a subdomain, and the nameserver 112 is authoritative for the domain and the subdomain. The backend unit 116 can return NS records associated with the subdomain to the signing service 114. The NS records can include flagged NS record that includes a key value can map to signing material for the subdomain. The signing service 114 can use the key value associated with the child NS records to access the signing material database 118. The signing service 114 can sign the DNS response using the signing material and return the response to the DNS resolver 106.

In another example, the query from the DNS resolver 106 may be for the subdomain and the nameserver 112 is not authoritative for the subdomain. Furthermore, the authoritative nameserver for the subdomain may be DNSSEC-enabled. The signing service 114 can request records for the subdomain from the backend unit 116. The backend unit 116 can return NS records for the subdomain including a flagged NS record. The flagged NS record can include a key value. The NS records can include delegation records that indicate the authoritative nameserver for the subdomain. As the backend unit 116 is returning records, the key value can map to signing material for the domain. Therefore, the signing service 114 can sign the delegation records using the signing material associated with the domain. The DNS resolver 106 can validate the message using information in a RRSIG RR included in the response from the nameserver 112. The DNS resolver 106 can further use the delegation records to identify the authoritative nameserver for the subdomain. The DNS resolver 106 can then communicate directly with the authoritative nameserver for the subdomain to obtain the A record for the subdomain. The authoritative nameserver for the subdomain can use its own signing materials to sign the response to the DNS resolver 106.

There can be various reasons why the nameserver 112 is not the authoritative nameserver for the subdomain. For example, a CSP customer that manages both the domain and the subdomain prefers the separate server configuration. Furthermore, the nameserver 112 can be DNSSEC-enabled, whereas the authoritative nameserver for the subdomain may not be DNSSEC-enabled.

In another example, the query from the DNS resolver 106 may be for the subdomain and the nameserver 112 is authoritative for the subdomain. Furthermore, the authoritative nameserver for the subdomain may not be DNSSEC-enabled. The signing service 114 can request records for the subdomain from the backend unit 116. The backend unit 116 can return records for the subdomain. However, in this example, the records may not include a flagged NS record. The NS records can still include records that indicate the authoritative nameserver for the subdomain as above.

In this example, the signing service 114 can determine that there is no flagged NS record. Therefore, the signing service 114 may not access the signing material database 118. Rather, the signing service may return RR records without a cryptographic signature. The DNS resolver 106 may determine that no RRSIG RR is included in the response and therefore no message validation is to be performed. The DNS resolver 106 can provide the A record to the application 104. The application 104 can use the A record to communicate with the subdomain.

Therefore, it can be seen that the flagged NS record can enable a proxy, such as a signing service 114, to determine whether a DNS response should include a cryptographic signature. As indicated above, a conventional system can rely on exhaustive lists of each domain and subdomain to enable the nameserver to determine whether or not a response should be signed. Furthermore, some conventional systems can be configured to recursively cycle through each suffix in the list to determine whether or not there is signing material. Consider an example in which the conventional system's parent zone may be DNSSEC-enabled and the child zone may not be DNSSEC-enabled. A conventional DNS resolver may transmit a request for a record related to the subdomain (e.g., service.example.com), which is not DNSSEC-enabled. The request can be received by the conventional authoritative nameserver for the parent zone. The conventional authoritative nameserver can determine different combinations of suffixes for the request's domain (e.g., .com, example.com, service.example.com). The conventional authoritative nameserver may recursively loop through each suffix in the list to determine if there is signing material. For example, the conventional authoritative nameserver may search the list for .com and determine that there is no signing material. The conventional authoritative nameserver may search the list for service.example.com and determine that there is no signing material. The conventional authoritative nameserver may search the list for example.com and determine that there is signing material. The conventional authoritative nameserver may then sign the response associated with service.example.com using signing material for example.com. This may be incorrect as service.example.com is not DNSSEC-enabled, and therefore the DNS response should be unsigned. However, as there is a suffix variation (e.g., example.com) that is DNSSEC-enabled, the conventional authoritative nameserver may sign the DNS response.

The herein embodiments may use the flagged NS record to control the behavior of the signing service 114. In the instance that the signing service 114 detects the flagged NS record, the signing service uses the key value to access the signing material from the signing material database 118. The signing service 114 can then use the signing material to generate a cryptographic signature and include the cryptographic signature in the DNS response. If there is no flagged NS record, the signing service transmits the DNS response without a cryptographic signature.

In any case, the DNS resolver 106 can cache the information returned from the nameserver 112 and transmit the information to the application 104. The application 104 can use the information (e.g., an IP address) to connect to the domain.

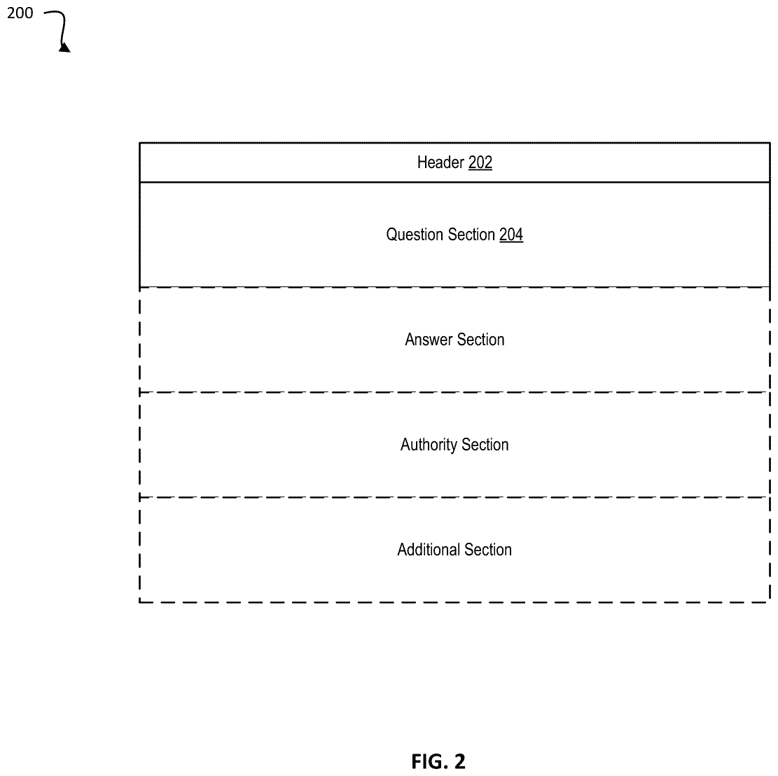

FIG. 2 is an illustration 200 of an example DNS query message format, according to one or more embodiments. The DNS protocol includes three types of messages, queries, responses, and updates. A DNS query message can include two sections: a header 202 and a question section 204.

The header 202 can include various identifying information. For example, the header 202 can include a transaction identifier to match the DNS query message to a DNS response message. The header 202 can include a bit indicating the number of queries in the question section 204. The header 202 can include various other information to communicate to the recipient of the DNS query message. For example, the header can include counts for a number of answer resource records, a count of the number of authority records, and a count of the number of additional resource records. As this is a DNS query message and no answers have been provided, these counts may be zero.

The question section 204 can include a question that includes three parts, a query, a question type, and a question class. For example, the question can identify the target domain (e.g., www.child.example.com), and the record type (e.g., Type A, where “A” can include an address record). Other record types can include, for example, CNAME for canonical domain name or MX for mail server. The question can also include the class (e.g., IN, where “IN” can include internet.)

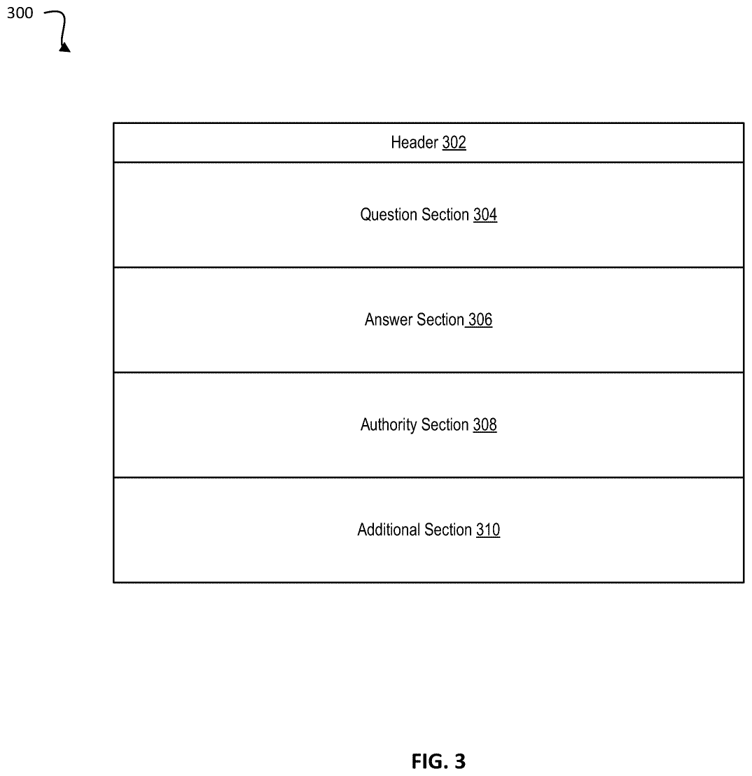

FIG. 3 is an illustration 300 of an example DNS response message according to one or more embodiments. The DNS response message can include five sections, including the header 302, a question section 304, an answer section 306, an authority section 308, and an additional section 310. The header 302 can include a transaction identifier that matches the transaction identifier of the DNS query message. The header 302 can include a bit indicating the number of queries in the question section 304. This number may be the same number as indicated in the header 202 of the DNS query message. The header 302 can further include counts for a number of answer resource records, a count of the number of authority records, and a count of the number of additional resource records. These counts may depend on the number of resource records provided in the DNS response message.

The question section 304 can include the same information as the question section 204 of the DNS query message. The answer section 306 can include one or more resource records that are responsive to the question in the DNS query message. The authority section 308 can include one or more resource records that identify authoritative nameservers for responding to the question. For example, if the nameserver responding to the DNS query message is not the authoritative nameserver for the requested domain, the authority section 308 can provide the sender of the DNS query message, the identities of the authoritative nameserver(s) for the desired domain. For example, the query may be for child.example.com, and the server generating the DNS response message may not be the authoritative server for child.example.com. The nameserver can provide the identity of the authoritative nameserver for child.example.com in the authority section 308. The additional section 310 can include additional resource records that can be useful for the response. For example, the additional section can include DNSSEC related data. It should be appreciated that DNSSEC-related data can be in various forms. For example, an RRSIG can appear within the same section as the RRSET that it signs. Another example can be an A type RR corresponding to an NS RR in an authority section. Another example can include EDNS data that includes a bit indicating that a resolver that is generating a query is DNSSEC-enabled wants RRSIGS to be included in a response.

FIG. 4 is an illustration of an example DNS zone file 400, according to one or more embodiments. A DNS zone file 400 can be a text file is a representation of zone and include resource records for every domain within the zone. The DNS zone file 400 can be stored by a backend unit (e.g., the backend unit 116). Furthermore, a nameserver (e.g., nameserver 112), and in particular a signing service (e.g., signing service 114) can access the DNS zone file 400 for information to populate the DNS response message. The DNS zone file 400 can include start of authority (SOA) records 402. The SOA record 402 can include the identity for the primary authoritative server for the zone. As illustrated, the primary authoritative nameserver is identified as ns1.example.com. The SOA can further include a TTL, or how long a receiving server can cache and rely upon this information. The SOA record 402 can include other zone information. The SOA record 402 can be returned in response to a query. In some instances, the query can be for the SOA record of a particular domain (e.g., what is the SOA record for example.com?) In other instances, the SOA record 402 can be returned in a negative response. For example, the query may be, “what is the A record for excursion.com?” and the domain “excursion.com” may not exist. In this instance, the response can be an indication that the domain “excursion.com” does not exist. Furthermore, the SOA record may be provided in the response to indicate the authoritative source for the response.

The DNS zone 400 file can further include authoritative nameserver records 404, that indicate the authoritative server for a zone. A server can return NS records based on various scenarios. In a first scenario, a client device can request any type of resource record (RR) other than an NS record, where the RRs exist and the nameserver providing the answer is the authoritative nameserver for the zone. In this first scenario a response from nameserver may include any requested RRs in the DNS answer section and NS records for the zone in the DNS authority section.

In a second scenario, a client device can request a RR of any type for a zone, where the nameserver providing the answer not the authoritative nameserver for the child zone, but is the authoritative nameserver for the domain's zone. The response to the request may include an empty answer section. The response may, however, include NS records for a child zone defined by the parent zone in the authority section.

In a third scenario, a client device can request NS records for a zone, where the nameserver providing the answer is the authoritative server for the zone. The response can include the requests RRs in the answer section. The NS records may not be repeated in the authority section.

In a fourth scenario, a client device can request RRs of any type for a zone. In this scenario the requested RRs may not exist, and the nameserver providing the answer may be authoritative for the zone. The response can include an empty answer section, and the response code can indicate NXDOMAIN (e.g., a non-existent zone), rather than NOERROR. The SOA record for the zone may be included in the authority section. In this scenario, no NS records may be included in the response.

It should be appreciated that each of the scenarios can result in either NS records included in the response (and therefore the presence or absence of flagged NS records can be determined) or the exact domain (e.g., parent domain) matching the signing material is known. For example, an SOA records associated with a domain (e.g., parent domain) can be signed with the domain's signing materials. Therefore, in this case a flagged NS record can be irrelevant.

In a conventional system, if an SOA record appears in the authority section of a response, then it may indicate that the response is for the zone of the SOA record's domain. A DNSSEC digital signature may be added for a response when the SOA record in the authority section is example.com, and a DNSSEC digital signature for example.com would not be applied when the SOA record in the authority section is child.example.com. The digital signature can be included in an RR signature (RRSIG) record. In all other cases, the conventional system may be unable to determine from the records in the response whether the response was related to example.com or to child.example.com, and therefore the nameserver's logic would not have a clear method to determine which actions to take.

The embodiments described herein can permit the server to disambiguate the parent zone from the child zone using a flag included in the NS records 404. As the DNS zone file 400 is generated or updated can include a flag record that indicates that nameserver is not the authoritative nameserver for a domain. As illustrated in FIG. 4, includes a first flagged NS record 406 that includes the suffix “invalid.” It should be appreciated that the suffix “invalid” is for illustrative purposes and can include various other text indicative of the flag.

The first flagged NS record 406 can be a signal as to whether an RR should be signed by a signing service providing a response. For example, a client device (e.g., client device 102) can transmit a question to a DNS resolver (e.g., DNS resolver 106) for a nameserver (e.g., NS record) for a domain. The DNS resolver can communicate with a root server (e.g., root DNS server 108) and a TLD server (TLD server 110) to determine the IP address of a DNSSEC-enabled nameserver (e.g., nameserver 112). The DNS resolver can transmit a question to the nameserver for the IP address of the domain. The question can be intercepted by a signing service (e.g., signing service 114) that can act as a proxy for a backend unit (e.g., backend unit 116). The signing service can communicate with the backend unit and access a DNS zone file 400 to determine the requested information.

The signing service can traverse the NS records 404 in the DNS zone file 400 or included in a DNS response 300 provided by a backend unit 116. As illustrated, there are six NS records. The signing service can further evaluate the suffixes of each NS record. As illustrated, there are four NS records with the suffix “com” and two NS records with the suffix “invalid.”

The first flagged NS record 406 may read:

| | | | |
|---|---|---|---|
| example.com | IN | NS | <key>.sign.invalid, |

where “example.com” can be include the domain for which the flag is associated. “IN” can indicate that the RR is an internet RR for an internet class. “NS” can indicate that the RR is an NS record. “<key> sign.invalid” can indicate the RR is a flag and include a key for determining the signing material (e.g., private key and public key) for example.com. Upon detecting, the “invalid” suffix, the signing service can determine that the signing material for the “example.com.”

In general, the first flagged NS record 406 can be considered a pointer that points the signing service to the signing materials for a domain. The <key> value can be any value, such as a hash value of a zone name. For example, the <key> value can be a 63 trailing bytes of a 64-byte SHA hash of a zone's name. The signing service can access a mapping stored in the memory of the nameserver and use the <key> value to identify the signing material (e.g., public key(s) and/or private key(s)) for the domain.

In one scenario, the nameserver can receive a question directed toward example.com (e.g., What is the IP address of example.com?) In this example, the <key> found in the first flagged NS record 406 can be a pointer for pointing the signing service to the signing material for example.com. The pointer can point to, for example, a file stored in a signing material database (e.g., signing material database 118). The signing service can sign any returned materials using the signing materials for example.net. The signing service can further store the digital signature in a RR signature (RRSIG) and return the RRSIG RR along with any RRs in an answer to the DNS resolver.

In another scenario, the nameserver can receive a question for child.example.com from a DNS resolver. In this scenario, the nameserver is authoritative for example.com, but not the authoritative server for child.example.com. The signing service can query a backend unit for any requested record, such as an NS record for child.example.com. It can further be seen from the DNS zone file 400, that the nameserver may be authoritative for example.com, but may not be authoritative for child.example.com. For example, if nameserver is not authoritative for child.example.com, the NS record at example.com may be:

| | | | |
|---|---|---|---|
| child .example.com | IN | NS | another-provider-1.com. |

However, if the nameserver were authoritative for the child.example.com, the NS record at example.com may be:

| | | | |
|---|---|---|---|
| child .example.com | IN | NS | DNS-provider-1.com. |

The nameserver for example.com can receive a question for child.example.com from a DNS resolver, the signing service can query a backend unit for any requested record, such as an NS record. The nameserver can return the NS records:

| | | | |
|---|---|---|---|
| child.example.com | IN | NS | another-provider-1.com, |
| child.example.com | IN | NS | another-provider-2.com, and |
| child.example.com | IN | NS | <key>.sign.invalid. |

As the DNS zone file 400 is stored in the parent zone for example.com, if the signing service maps the <key> value to a record in a signing materials database, the signing service may identify signing materials for example.com. The signing service can include the following “delegation-to-another-provider” NS records in a DNS response:

| | | | |
|---|---|---|---|
| child.example.com | IN | NS | another-provider-1.com, and |
| child.example.com | IN | NS | another-provider-2.com. |

If the authoritative nameserver for child.example.com is DNSSEC-enabled, the signing service can further include a delegation server (DS) record along with the DNS response. The DS record can include a key tag that identifies a DNSKEY (e.g., public key) of the subdomain, an identity of a cryptographic algorithm used to generate the digital signature, an identity of a hash algorithm used to generate a hash value (e.g., digest), and the hash value. If the authoritative nameserver for child.example.com is not DNSSEC-enabled, the signing service may not include the DS record. The signing service can then use the value associated with <key> to access signing material for example.com. The signing service can then generate a digital signature for the DS record (if included in response), and NS records using the signing materials for example.com and store the digital signature in an RRSIG RR. The signing service can then return the RRSIG RRin an answer to the DNS resolver.

If DNSSEC-enabled, the DNS resolver can validate the response using the DS record. The DNS resolver can then identify the authoritative nameserver for child.example.com (e.g., another-provider-1.com) and communicate with the authoritative nameserver for child.example.com to get the A record (e.g., IP address) for child.example.com. The authoritative nameserver for child.example.com can further sign the DNS response to the DNS resolver using signing materials for child.example.com.

The techniques herein may assist an authoritative nameserver to disambiguate between domains. For example, currently conventional DNS systems may require that each authoritative service include a list that identifies each domain and each subdomain. The list may further include an indication as to whether each domain and subdomain is DNSSEC-enabled. The authoritative server in a conventional DNS system may have to recursively search through each entry in the list to determine whether or not the authoritative server should or should not sign for a subdomain and whether or not the authoritative nameserver (e.g., is the subdomain DNSSEC-enabled). Whereas the herein embodiments including introducing a flagged NS record in the NS records associated with the subdomain. It should be appreciated that for a parent zone that is not DNSSEC-enabled, no flagged entry may be present in the NS records. For example, an authoritative nameserver may receive a request for NS records of a domain (e.g., example.com). The authoritative nameserver can further be authoritative for the domain. The signing service can transmit a request to the backend unit for NS records for the domain. If the domain is DNSSEC-enabled, the NS records returned by the backend unit may appear as:

| | | | |
|---|---|---|---|
| example.com | IN | NS | dns-provider-1.com, |
| example.com | IN | NS | dns-provider-2.com, and |
| example.com | IN | NS | <key>.sign.invalid 406. |

In this first scenario, the signing service can detect the first flagged NS record 406 and use the <key> value to access a signing material database. If, however, the parent zone is not DNSSEC-enabled, the NS records returned by the backend unit may appear as:

| | | | |
|---|---|---|---|
| example.com | IN | NS | dns-provider-1.com, and |
| example.com | IN | NS | dns-provider-2.com. |

In this second scenario, the signing service can receive the NS records and not detect a flagged NS record. In this scenario, the signing service may not access a signing material database, as no flagged NS record is detected.

In a third scenario, an authoritative nameserver may receive a request for NS records of a subdomain (e.g., child.example.com), where the subdomain is DNSSEC-enabled. The authoritative nameserver can further for be authoritative for the domain, but not the subdomain. The signing service can transmit a request to the backend unit for NS records for the subdomain. The NS records returned for the subdomain by the backend unit may appear as:

| | | | |
|---|---|---|---|
| child.example.com | IN | NS | another-provider-1.com, |
| child.example.com | IN | NS | another-provider-2.com, and |
| child.example.com | IN | NS | <key>.sign.invalid 408. |

In this third scenario, the signing service can detect the second flagged NS record 408 and use the <key> value to access a signing material database. As the authoritative nameserver is in the parent zone, and therefore the signing material can be for the domain. The signing service can generate a DNS response that includes a cryptographic signature generated using the domain's signing materials. The authoritative nameserver can transmit the DNS response to the DNS resolver. The DNS resolver can use the NS records in the DNS response to communicate with the authoritative nameserver for the subdomain. The authoritative nameserver for the subdomain can provide a DNS response and sign the DNS response using signing materials for the subdomain (e.g., child.example.com).

In a fourth scenario, an authoritative nameserver may receive a request for NS records of a subdomain (e.g., child.example.com), where the subdomain is not DNSSEC-enabled. The authoritative nameserver can further for be authoritative for the domain, as well as the subdomain. The signing service can transmit a request to the backend unit for NS records for the subdomain. The NS records returned for the subdomain by the backend unit may appear as:

| | | | |
|---|---|---|---|
| child.example.com | IN | NS | dns-provider-1.com, and |
| child.example.com | IN | NS | dns-provider-2.com. |

It can be seen that backend unit does not return a flagged NS record as the subdomain is not DNSSEC-enabled. In this scenario, the authoritative nameserver would not be provisioned with a flagged NS record for the subdomain, and therefore would not return any flagged NS record to the signing service. The signing service can transmit an unsigned DNS response to the DNS resolver. If the DNS resolver receives resource records that answer the question from the application, the DNS resolver can transmit an unsigned DNS response to the application.

In a fourth scenario, an authoritative nameserver may receive a request for NS records of a subdomain (e.g., child.example.com), where the subdomain is DNSSEC-enabled. The authoritative nameserver can further for be authoritative for the domain, as well as the subdomain. The signing service can transmit a request to the backend unit for NS records for the subdomain. The NS records returned for the subdomain by the backend unit may appear as:

| | | | |
|---|---|---|---|
| child.example.com | IN | NS | dns-provider-1.com, and |
| child.example.com | IN | NS | dns-provider-2.com. |
| child.example.com | IN | NS | <child-key>.sign.invalid 408. |

In this fourth scenario, the signing service can detect the flagged NS record 408 and use the <child-key> value to access a signing material database. The signing service can generate a DNS response that includes a cryptographic signature generated using the subdomain's signing materials.

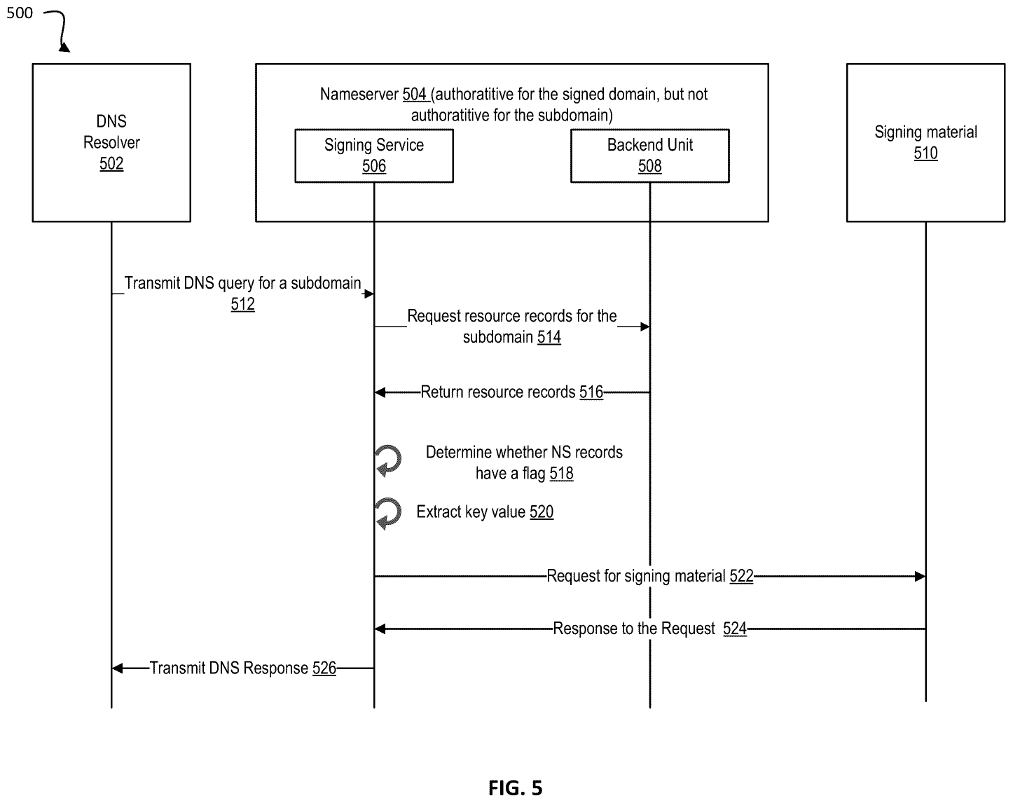

FIG. 5 is an example signaling diagram 500 for generating a DNS response, according to one or more embodiments. As illustrated, a DNS resolver 502 can be in operable communication with a nameserver 504. The nameserver 504 can be authoritative for a signed domain, but not authoritative for a subdomain. The nameserver 504 can include a signing service 506 and a backend unit 508. The nameserver 504 can further be in operable communication with a signing material database 510. While the operations of processes 500, 600, and 700, are described as being performed by generic computers, it should be understood that any suitable device may be used to perform one or more operations of these processes. Processes 500, 600, and 700 (described below) are respectively illustrated as logical flow diagrams, each operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

At 512, a DNS resolver can transmit a first DNS query for resource records associated with a subdomain. The DNS query can be in response to a query from an application on a client device. The DNS query can be for various records, such as NS records, A records, and MX records.

At 514, the first DNS query can be received by a signing service 506 that identifies the subdomain and transmits a second DNS query to a backend unit 508.

At 516, the backend unit 508 can return the requested resource records in a resource records set (RRSET). The RRSET can include NS records. The NS records may appear as:

| | | | |
|---|---|---|---|
| child.example.com | IN | NS | another-provider-1.com, |
| child.example.com | IN | NS | another-provider-2.com, and |
| child.example.com | IN | NS | <key>.sign.invalid. |

At 518, the signing service 506 can determine whether the NS records include a flagged NS record. As illustrated, the NS records for the subdomain include the flagged NS record;

| | | | |
|---|---|---|---|
| child.example.com | IN | NS | <key>.sign.invalid. |

At 520, the signing service can extract the <key> value from the flagged NS record. The <key> value can be any value used to map to signing material in the signing material database. For example, the <key> value can be a 63 trailing bytes of a 64-byte SHA hash of the parent zone's name.

At 522, the signing service can transmit a request for the signing material to the signing material database 510. The request can include the <key> value. The <key> value can be an index value that maps to the signing material. As the nameserver 504 is authoritative for the domain and the NS records a returned from the parent zone. The signing material can be signing material for the domain.

At 524, the signing material database 510 can return the signing material for the domain to the signing service 506. The signing service can generate a cryptographic signature using the signing material and store the cryptographic signature in an RRSIG RR.

At 526, the signing service 506 can transmit the DNS response, including the resource records returned by the backend unit 508 and the RRSIG RR to the DNS resolver 502. If the DNS resolver has the resource records to answer the application's query, it can return a DNS response to the application. If the DNS resolver is requested to contact the authoritative server for the subdomain, the DNS resolver can use the resource records returned by the signing service at 524 and communicate with the authoritative nameserver for the subdomain. The authoritative nameserver for the subdomain can return a signed DNS response to the DNS resolver 502. The DNS resolver can then return the signed DNS response to the application.

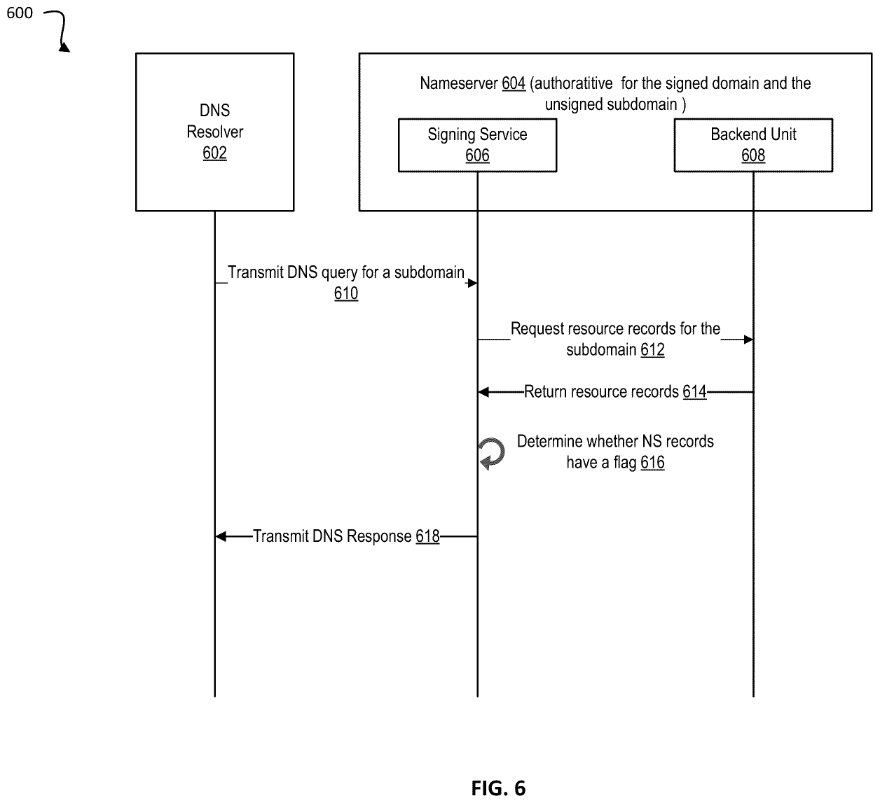

FIG. 6 is an example signaling diagram 600 for generating a DNS response, according to one or more embodiments. As illustrated, a DNS resolver 602 can be in operable communication with a nameserver 604. The nameserver 604 can include a signing service 606 and a backend unit 608. The nameserver 604 can be authoritative for a signed domain and for an unsigned subdomain.

The nameserver 604 can further be in operable communication with a signing material database. At 610, a DNS resolver can transmit a first DNS query for resource records associated with a subdomain. The DNS query can be in response to a query from an application on a client device. The DNS query can be for various records, such as NS records, A records, and MX records.

At 612, the first DNS query can be received by a signing service 606 that identifies the subdomain and transmits a second DNS query to a backend unit 608.

At 614, the backend unit 608 can return the requested resource records in a RRSET. The RRSET can include NS records. As the subdomain may not be DNSSEC-enabled, the NS records may appear as:

| | | | |
|---|---|---|---|
| child.example.com | IN | NS | dns-provider-1.com, and |
| child.example.com | IN | NS | dns-provider-2.com. |

At 616, the signing service 506 can determine whether the NS records include a flagged NS record. As illustrated, the NS records may not include the flagged NS record. Therefore, the signing service does not communicate with a signing material database for any signing material.

At 618, the signing service 606 can transmit the DNS response, including the resource records returned by the backend unit 608 to the DNS resolver 602. The DNS resolver can then return the unsigned DNS response to the application.

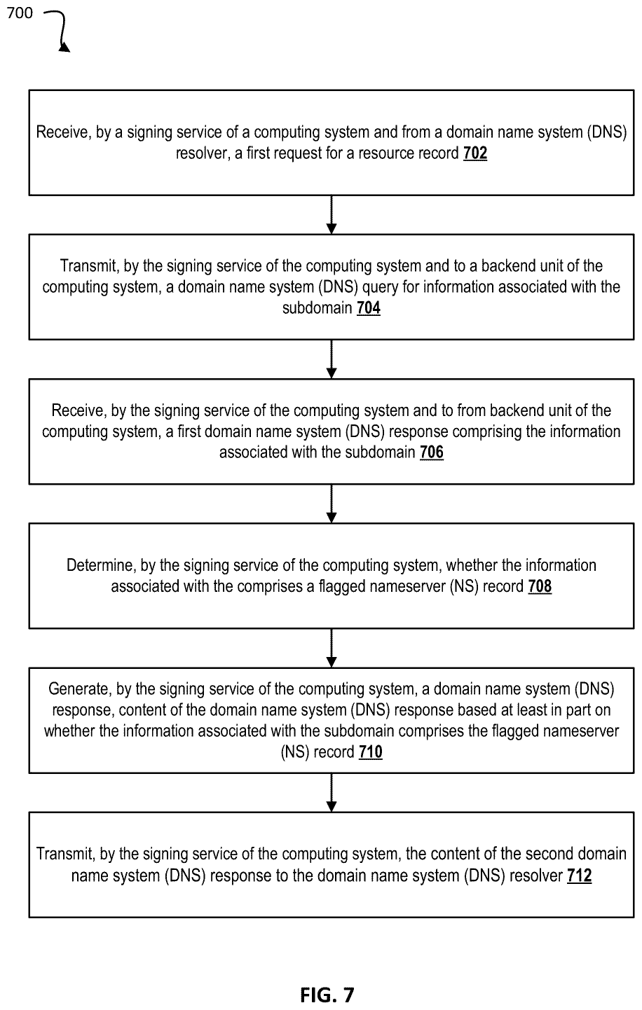

FIG. 7 is an example process flow 700 for generating a DNS response, according to one or more embodiments. At 702, the method can include a signing service of a system (e.g., nameserver 112 for a domain (example.com) receiving, from a DNS resolver (e.g., DNS resolver 106), a first request for a RR .com

At 704, the method can include the signing service (e.g., signing service 114) of the computing system transmitting to a backend unit (e.g., backend unit 116) of the computing system, a DNS query for information associated with a subdomain.

At 706, the method can include the signing service of the computing system receiving, from the backend unit of the computing system, a first DNS response comprising the information (e.g., A records, NS records, MX records) associated with the subdomain. The response can include NS records that may or may not include a flagged NS record.

At 708, the method can include the signing service of the computing system determining whether the information associated with the subdomain comprises a flagged NS record. The signing service can identify a NS record from the information associated with the subdomain. The signing service can then determine whether the NS comprises a suffix (e.g., .invalid) associated with a flag indicative of flagged NS record. The signing service can be configured to recognize the suffix and search for a <key> value in the flagged NS record based at least in part on the suffix. The <key> value can be used as a mapping tool to sign material (e.g., a public key and/or a private key) associated with the domain. The signing material can be stored in a signing material database.

At 710, the method can include signing service of the computing system generating a second DNS response, content of the DNS response based at least in part on whether the information associated with the subdomain comprises the flagged NS record. The content can include a resource records (RRs) that are included with a DNS response message. The DNS response can be similar to the DNS response described with respect to FIG. 3. If the information associated with the subdomain comprises a flagged NS record, the signing service can access the signing material from the signing service. The signing service can further generate a cryptographic signature and store the cryptographic signature in an RRSIG file. The resource record signature RRSIG file can be included in a response from the signing service to the DNS resolver.

At 712, the method can include the signing service of the computing system transmitting the second DNS response to the domain name system (DNS) resolver. The domain name system (DNS) resolver can provide the response to a client deviceAs noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

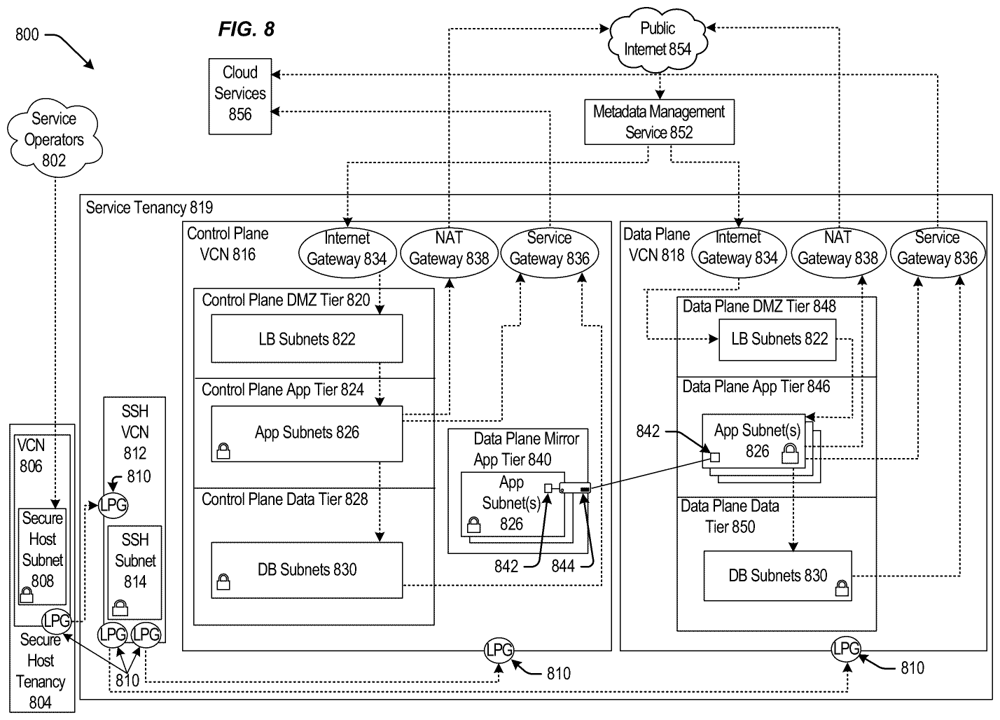

FIG. 8 is a block diagram 800 illustrating an example pattern of an IaaS architecture, according to at least one embodiment. Service operators 802 can be communicatively coupled to a secure host tenancy 804 that can include a virtual cloud network (VCN) 806 and a secure host subnet 808. In some examples, the service operators 802 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 806 and/or the Internet.

The VCN 806 can include a local peering gateway (LPG) 810 that can be communicatively coupled to a secure shell (SSH) VCN 812 via an LPG 810 contained in the SSH VCN 812. The SSH VCN 812 can include an SSH subnet 814, and the SSH VCN 812 can be communicatively coupled to a control plane VCN 816 via the LPG 810 contained in the control plane VCN 816. Also, the SSH VCN 812 can be communicatively coupled to a data plane VCN 818 via an LPG 810. The control plane VCN 816 and the data plane VCN 818 can be contained in a service tenancy 819 that can be owned and/or operated by the IaaS provider.

The control plane VCN 816 can include a control plane demilitarized zone (DMZ) tier 820 that acts as a perimeter network (e.g., portions of a corporate network between the corporate intranet and external networks). The DMZ-based servers may have restricted responsibilities and help keep breaches contained. Additionally, the DMZ tier 820 can include one or more load balancer (LB) subnet(s) 822, a control plane app tier 824 that can include app subnet(s) 826, a control plane data tier 828 that can include database (DB) subnet(s) 830 (e.g., frontend DB subnet(s) and/or backend DB subnet(s)). The LB subnet(s) 822 contained in the control plane DMZ tier 820 can be communicatively coupled to the app subnet(s) 826 contained in the control plane app tier 824 and an Internet gateway 834 that can be contained in the control plane VCN 816, and the app subnet(s) 826 can be communicatively coupled to the DB subnet(s) 830 contained in the control plane data tier 828 and a service gateway 836 and a network address translation (NAT) gateway 838. The control plane VCN 816 can include the service gateway 836 and the NAT gateway 838.

The control plane VCN 816 can include a data plane mirror app tier 840 that can include app subnet(s) 826. The app subnet(s) 826 contained in the data plane mirror app tier 840 can include a virtual network interface controller (VNIC) 842 that can execute a compute instance 844. The compute instance 844 can communicatively couple the app subnet(s) 826 of the data plane mirror app tier 840 to app subnet(s) 826 that can be contained in a data plane app tier 846.

The data plane VCN 818 can include the data plane app tier 846, a data plane DMZ tier 848, and a data plane data tier 850. The data plane DMZ tier 848 can include LB subnet(s) 822 that can be communicatively coupled to the app subnet(s) 826 of the data plane app tier 846 and the Internet gateway 834 of the data plane VCN 818. The app subnet(s) 826 can be communicatively coupled to the service gateway 836 of the data plane VCN 818 and the NAT gateway 838 of the data plane VCN 818. The data plane data tier 850 can also include the DB subnet(s) 830 that can be communicatively coupled to the app subnet(s) 826 of the data plane app tier 846.

The Internet gateway 834 of the control plane VCN 816 and of the data plane VCN 818 can be communicatively coupled to a metadata management service 852 that can be communicatively coupled to public Internet 854. Public Internet 854 can be communicatively coupled to the NAT gateway 838 of the control plane VCN 816 and of the data plane VCN 818. The service gateway 836 of the control plane VCN 816 and of the data plane VCN 818 can be communicatively coupled to cloud services 856.

In some examples, the service gateway 836 of the control plane VCN 816 or of the data plane VCN 818 can make application programming interface (API) calls to cloud services 856 without going through public Internet 854. The API calls to cloud services 856 from the service gateway 836 can be one-way: the service gateway 836 can make API calls to cloud services 856, and cloud services 856 can send requested data to the service gateway 836. But, cloud services 856 may not initiate API calls to the service gateway 836.

In some examples, the secure host tenancy 804 can be directly connected to the service tenancy 819, which may be otherwise isolated. The secure host subnet 808 can communicate with the SSH subnet 814 through an LPG 810 that may enable two-way communication over an otherwise isolated system. Connecting the secure host subnet 808 to the SSH subnet 814 may give the secure host subnet 808 access to other entities within the service tenancy 819.

The control plane VCN 816 may allow users of the service tenancy 819 to set up or otherwise provision desired resources. Desired resources provisioned in the control plane VCN 816 may be deployed or otherwise used in the data plane VCN 818. In some examples, the control plane VCN 816 can be isolated from the data plane VCN 818, and the data plane mirror app tier 840 of the control plane VCN 816 can communicate with the data plane app tier 846 of the data plane VCN 818 via VNICs 842 that can be contained in the data plane mirror app tier 840 and the data plane app tier 846.

In some examples, users of the system, or customers, can make requests, for example create, read, update, or delete (CRUD) operations, through public Internet 854 that can communicate the requests to the metadata management service 852. The metadata management service 852 can communicate the request to the control plane VCN 816 through the Internet gateway 834. The request can be received by the LB subnet(s) 822 contained in the control plane DMZ tier 820. The LB subnet(s) 822 may determine that the request is valid, and in response to this determination, the LB subnet(s) 822 can transmit the request to app subnet(s) 826 contained in the control plane app tier 824. If the request is validated and requires a call to public Internet 854, the call to public Internet 854 may be transmitted to the NAT gateway 838 that can make the call to public Internet 854. Metadata that may be desired to be stored by the request can be stored in the DB subnet(s) 830.

In some examples, the data plane mirror app tier 840 can facilitate direct communication between the control plane VCN 816 and the data plane VCN 818. For example, changes, updates, or other suitable modifications to configuration may be desired to be applied to the resources contained in the data plane VCN 818. Via a VNIC 842, the control plane VCN 816 can directly communicate with, and can thereby execute the changes, updates, or other suitable modifications to configuration to, resources contained in the data plane VCN 818.

In some embodiments, the control plane VCN 816 and the data plane VCN 818 can be contained in the service tenancy 819. In this case, the user, or the customer, of the system may not own or operate either the control plane VCN 816 or the data plane VCN 818. Instead, the IaaS provider may own or operate the control plane VCN 816 and the data plane VCN 818, both of which may be contained in the service tenancy 819. This embodiment can enable isolation of networks that may prevent users or customers from interacting with other users', or other customers', resources. Also, this embodiment may allow users or customers of the system to store databases privately without needing to rely on public Internet 854, which may not have a desired level of threat prevention, for storage.

In other embodiments, the LB subnet(s) 822 contained in the control plane VCN 816 can be configured to receive a signal from the service gateway 836. In this embodiment, the control plane VCN 816 and the data plane VCN 818 may be configured to be called by a customer of the IaaS provider without calling public Internet 854. Customers of the IaaS provider may desire this embodiment since database(s) that the customers use may be controlled by the IaaS provider and may be stored on the service tenancy 819, which may be isolated from public Internet 854.

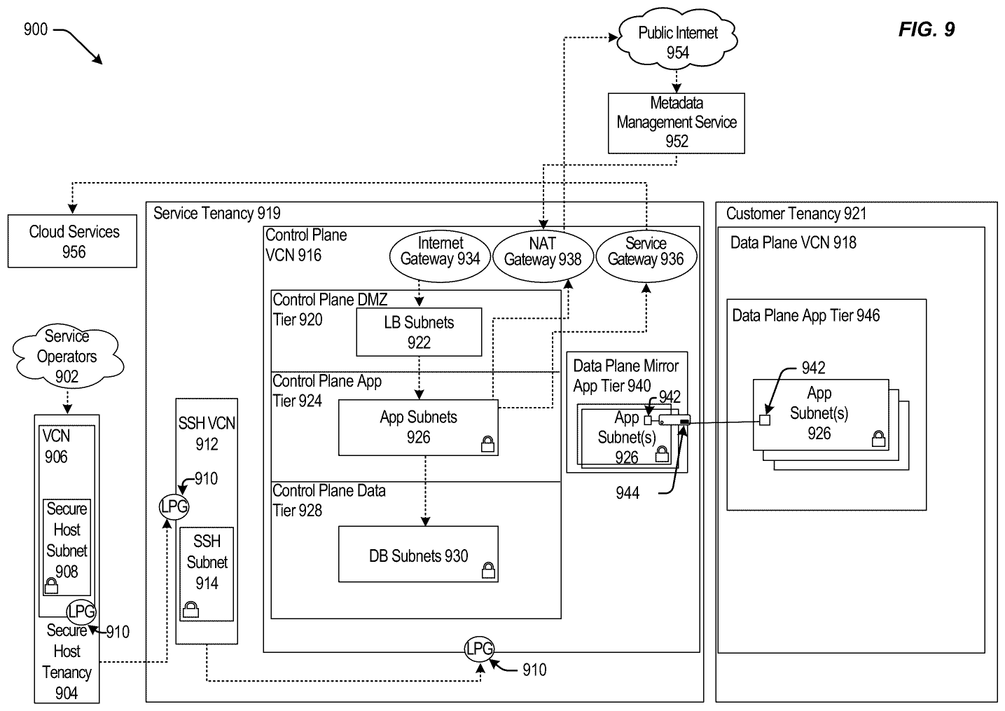

FIG. 9 is a block diagram 900 illustrating another example pattern of an IaaS architecture, according to at least one embodiment. Service operators 902 (e.g., service operators 802 of FIG. 8) can be communicatively coupled to a secure host tenancy 904 (e.g., the secure host tenancy 804 of FIG. 8) that can include a virtual cloud network (VCN) 906 (e.g., the VCN 806 of FIG. 8) and a secure host subnet 908 (e.g., the secure host subnet 808 of FIG. 8). The VCN 906 can include a local peering gateway (LPG) 910 (e.g., the LPG 810 of FIG. 8) that can be communicatively coupled to a secure shell (SSH) VCN 912 (e.g., the SSH VCN 812 of FIG. 8) via an LPG 810 contained in the SSH VCN 912. The SSH VCN 912 can include an SSH subnet 914 (e.g., the SSH subnet 814 of FIG. 8), and the SSH VCN 912 can be communicatively coupled to a control plane VCN 916 (e.g., the control plane VCN 816 of FIG. 8) via an LPG 910 contained in the control plane VCN 916. The control plane VCN 916 can be contained in a service tenancy 919 (e.g., the service tenancy 819 of FIG. 8), and the data plane VCN 918 (e.g., the data plane VCN 818 of FIG. 8) can be contained in a customer tenancy 921 that may be owned or operated by users, or customers, of the system.

The control plane VCN 916 can include a control plane DMZ tier 920 (e.g., the control plane DMZ tier 820 of FIG. 8) that can include LB subnet(s) 922 (e.g., LB subnet(s) 822 of FIG. 8), a control plane app tier 924 (e.g., the control plane app tier 824 of FIG. 8) that can include app subnet(s) 926 (e.g., app subnet(s) 826 of FIG. 8), a control plane data tier 928 (e.g., the control plane data tier 828 of FIG. 8) that can include database (DB) subnet(s) 930 (e.g., similar to DB subnet(s) 830 of FIG. 8). The LB subnet(s) 922 contained in the control plane DMZ tier 920 can be communicatively coupled to the app subnet(s) 926 contained in the control plane app tier 924 and an Internet gateway 934 (e.g., the Internet gateway 834 of FIG. 8) that can be contained in the control plane VCN 916, and the app subnet(s) 926 can be communicatively coupled to the DB subnet(s) 930 contained in the control plane data tier 928 and a service gateway 936 (e.g., the service gateway 836 of FIG. 8) and a network address translation (NAT) gateway 938 (e.g., the NAT gateway 838 of FIG. 8). The control plane VCN 916 can include the service gateway 936 and the NAT gateway 938.

The control plane VCN 916 can include a data plane mirror app tier 940 (e.g., the data plane mirror app tier 840 of FIG. 8) that can include app subnet(s) 926. The app subnet(s) 926 contained in the data plane mirror app tier 940 can include a virtual network interface controller (VNIC) 942 (e.g., the VNIC of 842) that can execute a compute instance 944 (e.g., similar to the compute instance 844 of FIG. 8). The compute instance 944 can facilitate communication between the app subnet(s) 926 of the data plane mirror app tier 940 and the app subnet(s) 926 that can be contained in a data plane app tier 946 (e.g., the data plane app tier 846 of FIG. 8) via the VNIC 942 contained in the data plane mirror app tier 940 and the VNIC 942 contained in the data plane app tier 946.

The Internet gateway 934 contained in the control plane VCN 916 can be communicatively coupled to a metadata management service 952 (e.g., the metadata management service 852 of FIG. 8) that can be communicatively coupled to public Internet 954 (e.g., public Internet 854 of FIG. 8). Public Internet 954 can be communicatively coupled to the NAT gateway 938 contained in the control plane VCN 916. The service gateway 936 contained in the control plane VCN 916 can be communicatively coupled to cloud services 956 (e.g., cloud services 856 of FIG. 8).

In some examples, the data plane VCN 918 can be contained in the customer tenancy 921. In this case, the IaaS provider may provide the control plane VCN 916 for each customer, and the IaaS provider may, for each customer, set up a unique compute instance 944 that is contained in the service tenancy 919. Each compute instance 944 may allow communication between the control plane VCN 916, contained in the service tenancy 919, and the data plane VCN 918 that is contained in the customer tenancy 921. The compute instance 944 may allow resources, that are provisioned in the control plane VCN 916 that is contained in the service tenancy 919, to be deployed or otherwise used in the data plane VCN 918 that is contained in the customer tenancy 921.

In other examples, the customer of the IaaS provider may have databases that live in the customer tenancy 921. In this example, the control plane VCN 916 can include the data plane mirror app tier 940 that can include app subnet(s) 926. The data plane mirror app tier 940 can reside in the data plane VCN 918, but the data plane mirror app tier 940 may not live in the data plane VCN 918. That is, the data plane mirror app tier 940 may have access to the customer tenancy 921, but the data plane mirror app tier 940 may not exist in the data plane VCN 918 or be owned or operated by the customer of the IaaS provider. The data plane mirror app tier 940 may be configured to make calls to the data plane VCN 918 but may not be configured to make calls to any entity contained in the control plane VCN 916. The customer may desire to deploy or otherwise use resources in the data plane VCN 918 that are provisioned in the control plane VCN 916, and the data plane mirror app tier 940 can facilitate the desired deployment, or other usage of resources, of the customer.

In some embodiments, the customer of the IaaS provider can apply filters to the data plane VCN 918. In this embodiment, the customer can determine what the data plane VCN 918 can access, and the customer may restrict access to public Internet 954 from the data plane VCN 918. The IaaS provider may not be able to apply filters or otherwise control access of the data plane VCN 918 to any outside networks or databases. Applying filters and controls by the customer onto the data plane VCN 918, contained in the customer tenancy 921, can help isolate the data plane VCN 918 from other customers and from public Internet 954.

In some embodiments, cloud services 956 can be called by the service gateway 936 to access services that may not exist on public Internet 954, on the control plane VCN 916, or on the data plane VCN 918. The connection between cloud services 956 and the control plane VCN 916 or the data plane VCN 918 may not be live or continuous. Cloud services 956 may exist on a different network owned or operated by the IaaS provider. Cloud services 956 may be configured to receive calls from the service gateway 936 and may be configured to not receive calls from public Internet 954. Some cloud services 956 may be isolated from other cloud services 956, and the control plane VCN 916 may be isolated from cloud services 956 that may not be in the same region as the control plane VCN 916. For example, the control plane VCN 916 may be located in “Region 1,” and cloud service “Deployment 8,” may be located in Region 1 and in “Region 2.” If a call to Deployment 8 is made by the service gateway 936 contained in the control plane VCN 916 located in Region 1, the call may be transmitted to Deployment 8 in Region 1. In this example, the control plane VCN 916, or Deployment 8 in Region 1, may not be communicatively coupled to, or otherwise in communication with, Deployment 8 in Region 2.

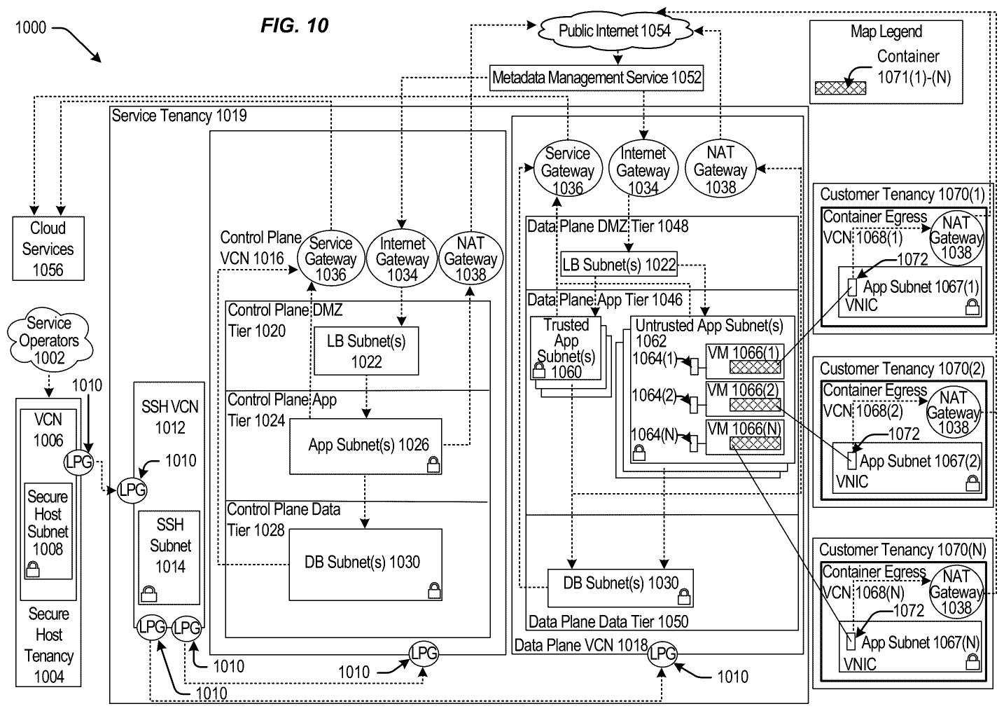

FIG. 10 is a block diagram 1000 illustrating another example pattern of an IaaS architecture, according to at least one embodiment. Service operators 1002 (e.g., service operators 802 of FIG. 8) can be communicatively coupled to a secure host tenancy 1004 (e.g., the secure host tenancy 804 of FIG. 8) that can include a virtual cloud network (VCN) 1006 (e.g., the VCN 806 of FIG. 8) and a secure host subnet 1008 (e.g., the secure host subnet 808 of FIG. 8). The VCN 1006 can include an LPG 1010 (e.g., the LPG 810 of FIG. 8) that can be communicatively coupled to an SSH VCN 1012 (e.g., the SSH VCN 812 of FIG. 8) via an LPG 1010 contained in the SSH VCN 1012. The SSH VCN 1012 can include an SSH subnet 1014 (e.g., the SSH subnet 814 of FIG. 8), and the SSH VCN 1012 can be communicatively coupled to a control plane VCN 1016 (e.g., the control plane VCN 816 of FIG. 8) via an LPG 1010 contained in the control plane VCN 1016 and to a data plane VCN 1018 (e.g., the data plane 818 of FIG. 8) via an LPG 1010 contained in the data plane VCN 1018. The control plane VCN 1016 and the data plane VCN 1018 can be contained in a service tenancy 1019 (e.g., the service tenancy 819 of FIG. 8).

The control plane VCN 1016 can include a control plane DMZ tier 1020 (e.g., the control plane DMZ tier 820 of FIG. 8) that can include load balancer (LB) subnet(s) 1022 (e.g., LB subnet(s) 822 of FIG. 8), a control plane app tier 1024 (e.g., the control plane app tier 824 of FIG. 8) that can include app subnet(s) 1026 (e.g., similar to app subnet(s) 826 of FIG. 8), a control plane data tier 1028 (e.g., the control plane data tier 828 of FIG. 8) that can include DB subnet(s) 1030. The LB subnet(s) 1022 contained in the control plane DMZ tier 1020 can be communicatively coupled to the app subnet(s) 1026 contained in the control plane app tier 1024 and to an Internet gateway 1034 (e.g., the Internet gateway 834 of FIG. 8) that can be contained in the control plane VCN 1016, and the app subnet(s) 1026 can be communicatively coupled to the DB subnet(s) 1030 contained in the control plane data tier 1028 and to a service gateway 1036 (e.g., the service gateway of FIG. 8) and a network address translation (NAT) gateway 1038 (e.g., the NAT gateway 838 of FIG. 8). The control plane VCN 1016 can include the service gateway 1036 and the NAT gateway 1038.

The data plane VCN 1018 can include a data plane app tier 1046 (e.g., the data plane app tier 846 of FIG. 8), a data plane DMZ tier 1048 (e.g., the data plane DMZ tier 848 of FIG. 8), and a data plane data tier 1050 (e.g., the data plane data tier 850 of FIG. 8). The data plane DMZ tier 1048 can include LB subnet(s) 1022 that can be communicatively coupled to trusted app subnet(s) 1060 and untrusted app subnet(s) 1062 of the data plane app tier 1046 and the Internet gateway 1034 contained in the data plane VCN 1018. The trusted app subnet(s) 1060 can be communicatively coupled to the service gateway 1036 contained in the data plane VCN 1018, the NAT gateway 1038 contained in the data plane VCN 1018, and DB subnet(s) 1030 contained in the data plane data tier 1050. The untrusted app subnet(s) 1062 can be communicatively coupled to the service gateway 1036 contained in the data plane VCN 1018 and DB subnet(s) 1030 contained in the data plane data tier 1050. The data plane data tier 1050 can include DB subnet(s) 1030 that can be communicatively coupled to the service gateway 1036 contained in the data plane VCN 1018.

The untrusted app subnet(s) 1062 can include one or more primary VNICs 1064(1)-(N) that can be communicatively coupled to tenant virtual machines (VMs) 1066(1)-(N). Each tenant VM 1066(1)-(N) can be communicatively coupled to a respective app subnet 1067(1)-(N) that can be contained in respective container egress VCNs 1068(1)-(N) that can be contained in respective customer tenancies 1070(1)-(N). Respective secondary VNICs 1072(1)-(N) can facilitate communication between the untrusted app subnet(s) 1062 contained in the data plane VCN 1018 and the app subnet contained in the container egress VCNs 1068(1)-(N). Each container egress VCNs 1068(1)-(N) can include a NAT gateway 1038 that can be communicatively coupled to public Internet 1054 (e.g., public Internet 854 of FIG. 8).

The Internet gateway 1034 contained in the control plane VCN 1016 and contained in the data plane VCN 1018 can be communicatively coupled to a metadata management service 1052 (e.g., the metadata management system 852 of FIG. 8) that can be communicatively coupled to public Internet 1054. Public Internet 1054 can be communicatively coupled to the NAT gateway 1038 contained in the control plane VCN 1016 and contained in the data plane VCN 1018. The service gateway 1036 contained in the control plane VCN 1016 and contained in the data plane VCN 1018 can be communicatively coupled to cloud services 1056.

In some embodiments, the data plane VCN 1018 can be integrated with customer tenancies 1070. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 1046. Code to run the function may be executed in the VMs 1066(1)-(N), and the code may not be configured to run anywhere else on the data plane VCN 1018. Each VM 1066(1)-(N) may be connected to one customer tenancy 1070. Respective containers 1071(1)-(N) contained in the VMs 1066(1)-(N) may be configured to run the code. In this case, there can be a dual isolation (e.g., the containers 1071(1)-(N) running code, where the containers 1071(1)-(N) may be contained in at least the VM 1066(1)-(N) that are contained in the untrusted app subnet(s) 1062), which may help prevent incorrect or otherwise undesirable code from damaging the network of the IaaS provider or from damaging a network of a different customer. The containers 1071(1)-(N) may be communicatively coupled to the customer tenancy 1070 and may be configured to transmit or receive data from the customer tenancy 1070. The containers 1071(1)-(N) may not be configured to transmit or receive data from any other entity in the data plane VCN 1018. Upon completion of running the code, the IaaS provider may kill or otherwise dispose of the containers 1071(1)-(N).

In some embodiments, the trusted app subnet(s) 1060 may run code that may be owned or operated by the IaaS provider. In this embodiment, the trusted app subnet(s) 1060 may be communicatively coupled to the DB subnet(s) 1030 and be configured to execute CRUD operations in the DB subnet(s) 1030. The untrusted app subnet(s) 1062 may be communicatively coupled to the DB subnet(s) 1030, but in this embodiment, the untrusted app subnet(s) may be configured to execute read operations in the DB subnet(s) 1030. The containers 1071(1)-(N) that can be contained in the VM 1066(1)-(N) of each customer and that may run code from the customer may not be communicatively coupled with the DB subnet(s) 1030.

In other embodiments, the control plane VCN 1016 and the data plane VCN 1018 may not be directly communicatively coupled. In this embodiment, there may be no direct communication between the control plane VCN 1016 and the data plane VCN 1018. However, communication can occur indirectly through at least one method. An LPG 1010 may be established by the IaaS provider that can facilitate communication between the control plane VCN 1016 and the data plane VCN 1018. In another example, the control plane VCN 1016 or the data plane VCN 1018 can make a call to cloud services 1056 via the service gateway 1036. For example, a call to cloud services 1056 from the control plane VCN 1016 can include a request for a service that can communicate with the data plane VCN 1018.

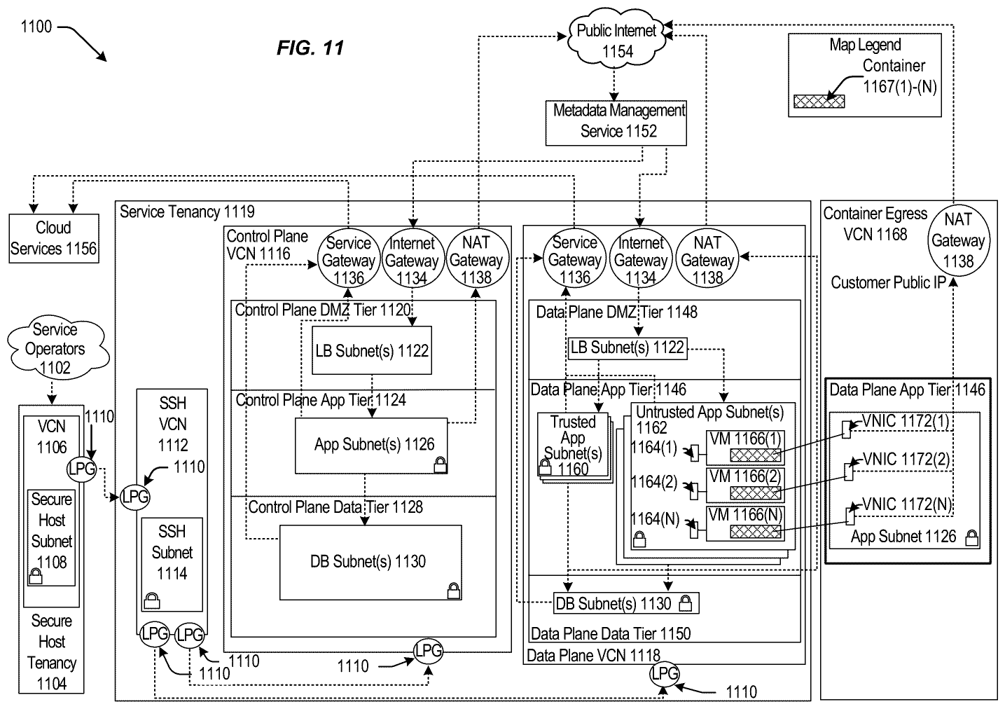

FIG. 11 is a block diagram 1100 illustrating another example pattern of an IaaS architecture, according to at least one embodiment. Service operators 1102 (e.g., service operators 802 of FIG. 8) can be communicatively coupled to a secure host tenancy 1104 (e.g., the secure host tenancy 804 of FIG. 8) that can include a virtual cloud network (VCN) 1106 (e.g., the VCN 806 of FIG. 8) and a secure host subnet 1108 (e.g., the secure host subnet 808 of FIG. 8). The VCN 1106 can include an LPG 1110 (e.g., the LPG 810 of FIG. 8) that can be communicatively coupled to an SSH VCN 1112 (e.g., the SSH VCN 812 of FIG. 8) via an LPG 1110 contained in the SSH VCN 1112. The SSH VCN 1112 can include an SSH subnet 1114 (e.g., the SSH subnet 814 of FIG. 8), and the SSH VCN 1112 can be communicatively coupled to a control plane VCN 1116 (e.g., the control plane VCN 816 of FIG. 8) via an LPG 1110 contained in the control plane VCN 1116 and to a data plane VCN 1118 (e.g., the data plane 818 of FIG. 8) via an LPG 1110 contained in the data plane VCN 1118. The control plane VCN 1116 and the data plane VCN 1118 can be contained in a service tenancy 1119 (e.g., the service tenancy 819 of FIG. 8).

The control plane VCN 1116 can include a control plane DMZ tier 1120 (e.g., the control plane DMZ tier 820 of FIG. 8) that can include LB subnet(s) 1122 (e.g., LB subnet(s) 822 of FIG. 8), a control plane app tier 1124 (e.g., the control plane app tier 824 of FIG. 8) that can include app subnet(s) 1126 (e.g., app subnet(s) 826 of FIG. 8), a control plane data tier 1128 (e.g., the control plane data tier 828 of FIG. 8) that can include DB subnet(s) 1130 (e.g., DB subnet(s) 1030 of FIG. 10). The LB subnet(s) 1122 contained in the control plane DMZ tier 1120 can be communicatively coupled to the app subnet(s) 1126 contained in the control plane app tier 1124 and to an Internet gateway 1134 (e.g., the Internet gateway 834 of FIG. 8) that can be contained in the control plane VCN 1116, and the app subnet(s) 1126 can be communicatively coupled to the DB subnet(s) 1130 contained in the control plane data tier 1128 and to a service gateway 1136 (e.g., the service gateway of FIG. 8) and a network address translation (NAT) gateway 1138 (e.g., the NAT gateway 838 of FIG. 8). The control plane VCN 1116 can include the service gateway 1136 and the NAT gateway 1138.

The data plane VCN 1118 can include a data plane app tier 1146 (e.g., the data plane app tier 846 of FIG. 8), a data plane DMZ tier 1148 (e.g., the data plane DMZ tier 848 of FIG. 8), and a data plane data tier 1150 (e.g., the data plane data tier 850 of FIG. 8). The data plane DMZ tier 1148 can include LB subnet(s) 1122 that can be communicatively coupled to trusted app subnet(s) 1160 (e.g., trusted app subnet(s) 1060 of FIG. 10) and untrusted app subnet(s) 1162 (e.g., untrusted app subnet(s) 1062 of FIG. 10) of the data plane app tier 1146 and the Internet gateway 1134 contained in the data plane VCN 1118. The trusted app subnet(s) 1160 can be communicatively coupled to the service gateway 1136 contained in the data plane VCN 1118, the NAT gateway 1138 contained in the data plane VCN 1118, and DB subnet(s) 1130 contained in the data plane data tier 1150. The untrusted app subnet(s) 1162 can be communicatively coupled to the service gateway 1136 contained in the data plane VCN 1118 and DB subnet(s) 1130 contained in the data plane data tier 1150. The data plane data tier 1150 can include DB subnet(s) 1130 that can be communicatively coupled to the service gateway 1136 contained in the data plane VCN 1118.

The untrusted app subnet(s) 1162 can include primary VNICs 1164(1)-(N) that can be communicatively coupled to tenant virtual machines (VMs) 1166(1)-(N) residing within the untrusted app subnet(s) 1162. Each tenant VM 1166(1)-(N) can run code in a respective container 1167(1)-(N), and be communicatively coupled to an app subnet 1126 that can be contained in a data plane app tier 1146 that can be contained in a container egress VCN 1168. Respective secondary VNICs 1172(1)-(N) can facilitate communication between the untrusted app subnet(s) 1162 contained in the data plane VCN 1118 and the app subnet contained in the container egress VCN 1168. The container egress VCN can include a NAT gateway 1138 that can be communicatively coupled to public Internet 1154 (e.g., public Internet 854 of FIG. 8).

The Internet gateway 1134 contained in the control plane VCN 1116 and contained in the data plane VCN 1118 can be communicatively coupled to a metadata management service 1152 (e.g., the metadata management system 852 of FIG. 8) that can be communicatively coupled to public Internet 1154. Public Internet 1154 can be communicatively coupled to the NAT gateway 1138 contained in the control plane VCN 1116 and contained in the data plane VCN 1118. The service gateway 1136 contained in the control plane VCN 1116 and contained in the data plane VCN 1118 can be communicatively coupled to cloud services 1156.

In some examples, the pattern illustrated by the architecture of block diagram 1100 of FIG. 11 may be considered an exception to the pattern illustrated by the architecture of block diagram 1000 of FIG. 10 and may be desirable for a customer of the IaaS provider if the IaaS provider cannot directly communicate with the customer (e.g., a disconnected region). The respective containers 1167(1)-(N) that are contained in the VMs 1166(1)-(N) for each customer can be accessed in real-time by the customer. The containers 1167(1)-(N) may be configured to make calls to respective secondary VNICs 1172(1)-(N) contained in app subnet(s) 1126 of the data plane app tier 1146 that can be contained in the container egress VCN 1168. The secondary VNICs 1172(1)-(N) can transmit the calls to the NAT gateway 1138 that may transmit the calls to public Internet 1154. In this example, the containers 1167(1)-(N) that can be accessed in real-time by the customer can be isolated from the control plane VCN 1116 and can be isolated from other entities contained in the data plane VCN 1118. The containers 1167(1)-(N) may also be isolated from resources from other customers.

In other examples, the customer can use the containers 1167(1)-(N) to call cloud services 1156. In this example, the customer may run code in the containers 1167(1)-(N) that requests a service from cloud services 1156. The containers 1167(1)-(N) can transmit this request to the secondary VNICs 1172(1)-(N) that can transmit the request to the NAT gateway that can transmit the request to public Internet 1154. Public Internet 1154 can transmit the request to LB subnet(s) 1122 contained in the control plane VCN 1116 via the Internet gateway 1134. In response to determining the request is valid, the LB subnet(s) can transmit the request to app subnet(s) 1126 that can transmit the request to cloud services 1156 via the service gateway 1136.

It should be appreciated that IaaS architectures 800, 900, 1000, 1100 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

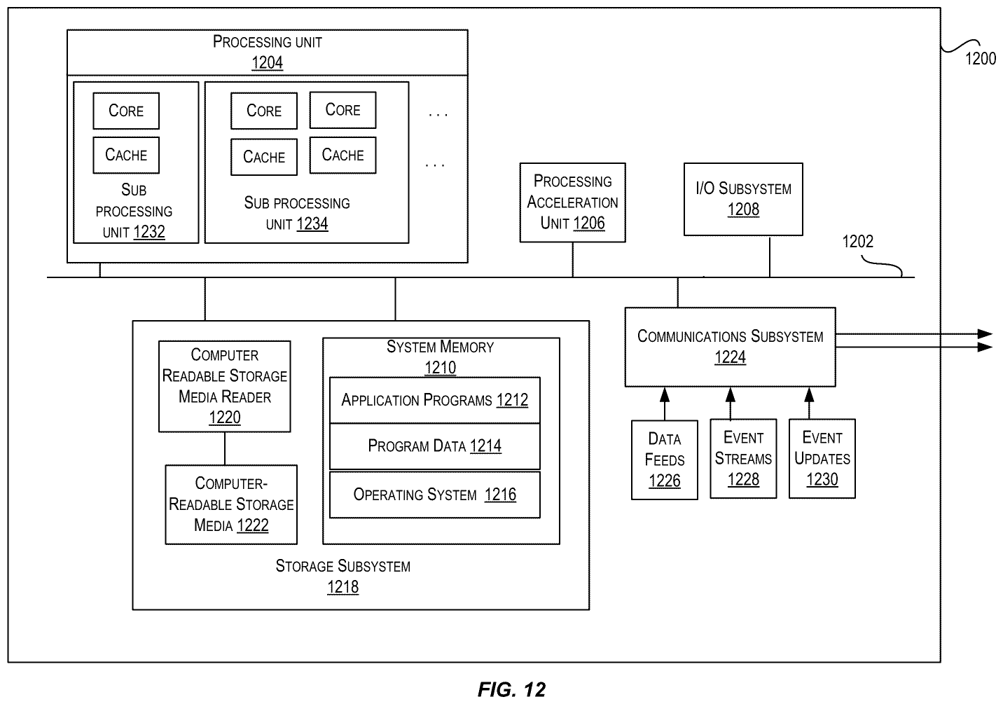

FIG. 12 illustrates an example computer system 1200, in which various embodiments may be implemented. The system 1200 may be used to implement any of the computer systems described above. As shown in the figure, computer system 1200 includes a processing unit 1204 that communicates with a number of peripheral subsystems via a bus subsystem 1202. These peripheral subsystems may include a processing acceleration unit 1206, an I/O subsystem 1208, a storage subsystem 1218 and a communications subsystem 1224. Storage subsystem 1218 includes tangible computer-readable storage media 1222 and a system memory 1210.

Bus subsystem 1202 provides a mechanism for letting the various components and subsystems of computer system 1200 communicate with each other as intended. Although bus subsystem 1202 is shown schematically as a single bus, alternative embodiments of the bus subsystem may utilize multiple buses. Bus subsystem 1202 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1204, which can be implemented as one or more integrated circuits (e.g., a conventional microprocessor or microcontroller), controls the operation of computer system 1200. One or more processors may be included in processing unit 1204. These processors may include single core or multicore processors. In certain embodiments, processing unit 1204 may be implemented as one or more independent processing units 1232 and/or 1234 with single or multicore processors included in each processing unit. In other embodiments, processing unit 1204 may also be implemented as a quad-core processing unit formed by integrating two dual-core processors into a single chip.

In various embodiments, processing unit 1204 can execute a variety of programs in response to program code and can maintain multiple concurrently executing programs or processes. At any given time, some or all of the program code to be executed can be resident in processor(s) 1204 and/or in storage subsystem 1218. Through suitable programming, processor(s) 1204 can provide various functionalities described above. Computer system 1200 may additionally include a processing acceleration unit 1206, which can include a digital signal processor (DSP), a special-purpose processor, and/or the like.

I/O subsystem 1208 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1200 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1200 may comprise a storage subsystem 1218 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1204 provide the functionality described above. Storage subsystem 1218 may also provide a repository for storing data used in accordance with the present disclosure.

As depicted in the example in FIG. 12, storage subsystem 1218 can include various components including a system memory 1210, computer-readable storage media 1222, and a computer readable storage media reader 1220. System memory 1210 may store program instructions that are loadable and executable by processing unit 1204. System memory 1210 may also store data that is used during the execution of the instructions and/or data that is generated during the execution of the program instructions. Various different kinds of programs may be loaded into system memory 1210 including but not limited to client applications, Web browsers, mid-tier applications, relational database management systems (RDBMS), virtual machines, containers, etc.

System memory 1210 may also store an operating system 1216. Examples of operating system 1216 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1200 executes one or more virtual machines, the virtual machines along with their guest operating systems (GOSs) may be loaded into system memory 1210 and executed by one or more processors or cores of processing unit 1204.

System memory 1210 can come in different configurations depending upon the type of computer system 1200. For example, system memory 1210 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1210 may include a basic input/output system (BIOS) containing basic routines that help to transfer information between elements within computer system 1200, such as during start-up.

Computer-readable storage media 1222 may represent remote, local, fixed, and/or removable storage devices plus storage media for temporarily and/or more permanently containing, storing, computer-readable information for use by computer system 1200 including instructions executable by processing unit 1204 of computer system 1200.

Computer-readable storage media 1222 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1222 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1222 may include, but is not limited to, Zip® drives, flash memory cards, universal serial bus (USB) flash drives, secure digital (SD) cards, DVD disks, digital video tape, and the like. Computer-readable storage media 1222 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1200.

Machine-readable instructions executable by one or more processors or cores of processing unit 1204 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1224 provides an interface to other computer systems and networks. Communications subsystem 1224 serves as an interface for receiving data from and transmitting data to other systems from computer system 1200. For example, communications subsystem 1224 may enable computer system 1200 to connect to one or more devices via the Internet. In some embodiments communications subsystem 1224 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 1224 can provide wired network connectivity (e.g., Ethernet) in addition to or instead of a wireless interface.

In some embodiments, communications subsystem 1224 may also receive input communication in the form of structured and/or unstructured data feeds 1226, event streams 1228, event updates 1230, and the like on behalf of one or more users who may use computer system 1200.

By way of example, communications subsystem 1224 may be configured to receive data feeds 1226 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1224 may also be configured to receive data in the form of continuous data streams, which may include event streams 1228 of real-time events and/or event updates 1230, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1224 may also be configured to output the structured and/or unstructured data feeds 1226, event streams 1228, event updates 1230, and the like to one or more databases that may be in communication with one or more streaming data source computers coupled to computer system 1200.

Computer system 1200 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1200 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A method, comprising:
receiving, by a signing service of a computing system and from a domain name system (DNS) resolver, a first request for a resource record (RR);
transmitting, by the signing service of the computing system and to a backend unit of the computing system, a domain name system (DNS) query for information associated with a subdomain;
receiving, by the signing service of the computing system and from the backend unit of the computing system, a first domain name system (DNS) response comprising the information associated with the subdomain;
determining, by the signing service of the computing system, whether the information associated with the subdomain comprises a flagged nameserver record;
generating, by the signing service of the computing system, a second domain name system (DNS) response, content of the second domain name system (DNS) response based at least in part on whether the information associated with the subdomain comprises the flagged nameserver record; and
transmitting, by the signing service of the computing system, the content of the second domain name system (DNS) response to the domain name system (DNS) resolver.

2. The method of claim 1, wherein the signing service of the computing system determines that the information associated with the subdomain comprises the flagged nameserver record, and wherein the method further comprises:
identifying a key value from the flagged nameserver record, the key value associated with signing material for the computing system;
transmitting a second request to a signing material database for the signing material for the computing system, wherein the second request comprises the key value;
receiving the signing material from the signing material database;
generating a cryptographic signature using the signing material; and
storing the cryptographic signature in a resource record signature (RRSIG) file, wherein the content comprises the resource record signature (RRSIG) file.

3. The method of claim 2, wherein key value comprises a hash value based at least in part on a domain identifier.

4. The method of claim 1, wherein the signing service of the computing system determines that the information associated with the subdomain comprises the flagged nameserver record, and wherein the method further comprises:
determining that the information associated with the subdomain comprises a resource record (RR) associated with the subdomain; and
filtering the flagged nameserver record from being included in the second domain name system (DNS) response, wherein the content comprises the resource record (RR) associated with the subdomain.

5. The method of claim 1, wherein the signing service of the computing system determines that the information associated with the subdomain comprises the flagged nameserver record, and wherein the content comprises the resource record (RR) associated with the subdomain and the flagged nameserver record.

6. The method of claim 1, wherein the signing service of the computing system determines that the information associated with the subdomain does not comprise the flagged nameserver record, and wherein the method further comprises:
determining that the information associated with the subdomain comprises a resource record (RR) associated with the subdomain, wherein the content comprises the resource record (RR) associated with the subdomain.

7. The method of claim 1, wherein determining whether the information associated with the subdomain comprises a flagged nameserver record comprises:
identifying a nameserver record from the information associated with the subdomain; and
determining whether the nameserver comprises a suffix associated with a flag indicative of flagged NS record.

8. A computing system comprising:
one or more processors; and
one or more computer-readable media having stored thereon a sequence of instructions that, when executed, cause the one or more processors to:
receive, by a signing service of the computing system and from a domain name system (DNS) resolver, a first request for a resource record (RR) associated with a subdomain;
transmit, by the signing service of the computing system and to a backend unit of the computing system, a domain name system (DNS) query for information;
receive, by the signing service of the computing system and from the backend unit of the computing system, a first domain name system (DNS) response comprising the information associated with a subdomain;
determine, by the signing service of the computing system, whether the information associated with the subdomain comprises a flagged nameserver record;
generate, by the signing service of the computing system, a second domain name system (DNS) response, content of the second domain name system (DNS) response based at least in part on whether the information associated with the subdomain comprises the flagged nameserver record; and
transmit, by the signing service of the computing system, the content of the second domain name system (DNS) response to the domain name system (DNS) resolver.

9. The computing system of claim 8, wherein the signing service of the computing system determines that the information associated with the subdomain comprises the flagged nameserver record, and wherein the sequence of instructions, when executed, further cause the one or more processors to:
identify a key value from the flagged nameserver record, the key value associated with signing material for the computing system;
transmit a second request to a signing material database for the signing material for the computing system, wherein the second request comprises the key value;
receive the signing material from the signing material database;
generate a cryptographic signature using the signing material; and
store the cryptographic signature in a resource record signature (RRSIG) file, wherein the content comprises the resource record signature (RRSIG) file.

10. The computing system of claim 9, wherein key value comprises a hash value based at least in part on a domain identifier.

11. The computing system of claim 8, wherein the signing service of the computing system determines that the information associated with the subdomain comprises the flagged nameserver record, and wherein the sequence of instructions, when executed, further cause the one or more processors to:
determining that the information associated with the subdomain comprises a resource record (RR) associated with the subdomain; and
filtering the flagged nameserver record from being included in the second domain name system (DNS) response, wherein the content comprises the resource record (RR) associated with the subdomain.

12. The computing system of claim 8, wherein the signing service of the computing system determines that the information associated with the subdomain comprises the flagged nameserver record, and wherein the content comprises the resource record (RR) associated with the subdomain and the flagged nameserver record.

13. The computing system of claim 8, wherein the signing service of the computing system determines that the information associated with the subdomain does not comprise the flagged nameserver record, and wherein the sequence of instructions, when executed, further cause the one or more processors to:
determine that the information associated with the subdomain comprises a resource record (RR) associated with the subdomain, wherein the content comprises the resource record (RR) associated with the subdomain.

14. The computing system of claim 8, wherein determining whether the information associated with the subdomain comprises a flagged nameserver record comprises:
identifying a nameserver record from the information associated with the subdomain; and
determining whether the nameserver comprises a suffix associated with a flag indicative of flagged NS record.

15. One or more non-transitory computer-readable media having stored thereon a sequence of instructions that, when executed by one or more processors of a computing system, cause the one or more processors to:
receive, by a signing service of the computing system and from a domain name system (DNS) resolver, a first request for a resource record (RR);
transmit, by the signing service of the computing system and to a backend unit of the computing system, a domain name system (DNS) query for information associated with a subdomain;
receive, by the signing service of the computing system and from backend unit of the computing system, a first domain name system (DNS) response comprising the information associated with the subdomain;
determine, by the signing service of the computing system, whether the information associated with the subdomain comprises a flagged nameserver record;
generate, by the signing service of the computing system, a second domain name system (DNS) response, content of the second domain name system (DNS) response based at least in part on whether the information associated with the subdomain comprises the flagged nameserver record; and
transmit, by the signing service of the computing system, the content of the second domain name system (DNS) response to the domain name system (DNS) resolver.

16. The one or more non-transitory computer-readable media of claim 15, wherein the signing service of the computing system determines that the information associated with the subdomain comprises the flagged nameserver record, and wherein the sequence of instructions that, when executed by one or more processors of a computing system, further cause the one or more processors to:
identify a key value from the flagged nameserver record, the key value associated with signing material for the computing system;
transmit a second request to a signing material database for the signing material for the computing system, wherein the second request comprises the key value;
receive the signing material from the signing material database;
generate a cryptographic signature using the signing material; and
store the cryptographic signature in a resource record signature (RRSIG) file, wherein the content comprises the resource record signature (RRSIG) file.

17. The one or more non-transitory computer-readable media of claim 16, wherein key value comprises a hash value based at least in part on a domain identifier.

18. The one or more non-transitory computer-readable media of claim 15, wherein the signing service of the computing system determines that the information associated with the subdomain comprises the flagged nameserver record, and wherein the sequence of instructions that, when executed by one or more processors of a computing system, further cause the one or more processors to:
determining that the information associated with the subdomain comprises a resource record (RR) associated with the subdomain; and
filtering the flagged nameserver record from being included in the second domain name system (DNS) response, wherein the content comprises the resource record (RR) associated with the subdomain.

19. The one or more non-transitory computer-readable media of claim 15, wherein the signing service of the computing system determines that the information associated with the subdomain comprises the flagged nameserver record, and wherein the content comprises the resource record (RR) associated with the subdomain and the flagged nameserver record.

20. The one or more non-transitory computer-readable media of claim 15, wherein the signing service of the computing system determines that the information associated with the subdomain does not comprise the flagged nameserver record, and wherein the sequence of instructions that, when executed by one or more processors of a computing system, further cause the one or more processors to:
determine that the information associated with the subdomain comprises a resource record (RR) associated with the subdomain, wherein the content comprises the resource record (RR) associated with the subdomain.
